(19) United States
(12) Patent Application Publication
(10) Pub. No.: US 2025/0106972 A1
(43) Pub. Date: Mar. 27, 2025

(54) X-RAY TUBES, METHODS AND SYSTEMS FOR ADJUSTING FOCAL POINTS OF X-RAY TUBES, AND CATHODE ASSEMBLIES

(71) Applicant: WUHAN UNITED IMAGING HEALTHCARE CO., LTD., Wuhan (CN)

(72) Inventors: Heng TANG, Wuhan (CN); Jiajia TIAN, Shanghai (CN); Sang LIU, Wuhan (CN); Zhikai HU, Wuhan (CN)

(73) Assignee: WUHAN UNITED IMAGING HEALTHCARE CO., LTD., Wuhan (CN)

(21) Appl. No.: 18/896,769

(22) Filed: Sep. 25, 2024

(30) Foreign Application Priority Data
Sep. 25, 2023 (CN) 202311246000.5
Sep. 25, 2023 (CN) 202311250583.9

(51) Int. Cl. H05G 1/52; H01J 35/02; H01J 35/06; H01J 35/18; H05G 1/26; H05G 1/32

(52) U.S. Cl. CPC H05G 1/52; H01J 35/025; H01J 35/064; H01J 35/18; H05G 1/265; H05G 1/32; H01J 2235/18

(57) ABSTRACT

Embodiments of the present disclosure provide an X-ray tube. The X-ray tube may include a cathode assembly. The cathode assembly may include: a cathode configured to emit an electron beam; a cathode adjustment window disposed at a periphery of the cathode; and a controller configured to adjust emittance of the electron beams emitted from the cathode at different tube voltages by adjusting a potential difference between the cathode adjustment window and the cathode, so that a size of an electron beam spot formed by the electron beam matches a target focal point size.

### CROSS-REFERENCE TO RELATED APPLICATIONS

This application claims priority of Chinese Patent Application No. 202311250583.9, filed on Sep. 25, 2023, and Chinese Patent Application No. 202311246000.5, filed on Sep. 25, 2023, the entire contents of each of which are incorporated herein by reference.

### TECHNICAL FIELD

The present disclosure relates to the field of X-ray technology, and in particular, to X-ray tubes, methods and systems for adjusting focal points of X-ray tubes, and cathode assemblies.

### BACKGROUND

Energy-spectrum Computed Tomography (CT) achieves quantitative imaging by providing a comparison of the attenuation of X-rays of different energies and reflecting the properties of the materials the X-rays penetrate. Current energy-spectrum CT includes a mode where two independent X-ray tube radiate different energies based on a dual-source system, a mode where a dual-energy spectrum is achieved based on left and right halves of one same radiation source with different filtrations, and a mode where photon signals of different energies are measured based on a double-layer detector or a photon-counting detector. However, none of the above modes achieves microsecond rapid switching of tube current and suppresses the ineffective dose. Even if the microsecond rapid switching of the tube current is achieved, the rapid switching of the tube current may result in a dramatic increase in emittance of an electron beam, a simultaneous increase in a size of a beam pipe, and a significant increase in a current of a focusing quadrupole magnet. Because a first quadrupole magnet focuses electrons in one direction but disperses electrons in another direction perpendicular to the first quadrupole magnet, it is not possible to focus an electron beam spot to a much smaller size, which prevents spatial resolution from further being improved due to the limitation of the size of the beam spot.

### SUMMARY

One of the embodiments of the present disclosure provides an X-ray tube. The X-ray tube may include a cathode structure. The cathode structure may include a cathode configured to emit an electron beam, a cathode adjustment window disposed at a periphery of the cathode, and a controller configured to adjust emittance of the electron beams emitted from the cathode at different tube voltages by adjusting a potential difference between the cathode adjustment window and the cathode, so that a size of an electron beam spot formed by the electron beam matches a target focal point size.

One of the embodiments of the present disclosure provides a method for adjusting a focal point of an X-ray tube. The X-ray tube may include a cathode and a cathode adjustment window, and the cathode may be configured to emit an electron beam. The method may include obtaining a target focal point size of the X-ray tube. The method may further include adjusting emittance of the electron beams emitted from the cathode at different tube voltages by adjusting a potential difference between the cathode adjustment window and the cathode, so that a size of an electron beam spot matches the target focal point size. The cathode adjustment window may be disposed at a periphery of the cathode.

One of the embodiments of the present disclosure provides an X-ray device. The X-ray device may include an X-ray tube. The X-ray tube may include a cathode structure. The cathode structure may include a cathode configured to emit an electron beam, a cathode adjustment window disposed at a periphery of the cathode, and a controller configured to adjust emittance of the electron beams emitted from the cathode at different tube voltages by adjusting a voltage of at least one of the cathode adjustment window and the cathode, so that a size of an electron beam spot formed by the electron beam matches a target focal point size.

In some embodiments of the present disclosure, the emittance of the electron beams emitted from the cathode at different tube voltages by adjusting, based on a target focal point size, a potential difference between a cathode adjustment window 216 and a cathode 212 may be adjusted, so that a focal point of any size (including an ultra-large range of focal point and an ultra-small range of focal point) may be obtained, thereby greatly expanding the adjustment of CT spatial resolution.

The cathode assembly provided in some embodiments of the present disclosure may include a flat cathode and a focusing electrode. The flat cathode may include a plurality of emission portions, each of which may be configured to independently emit an electron beam. The plurality of emission portions may be circumferentially arranged around a center of the flat cathode. The focusing electrode may be arranged around a periphery of the flat cathode. The focusing electrode may be set at a first acute angle towards a side of the flat cathode in a beam direction of the electron beam emitted from the flat cathode. The focusing electrode may be configured to focus the electron beam emitted from each of the plurality of emission portions. The flat cathode in the present disclosure may include a plurality of emission portions. Each of the plurality of emission portions may emit the electron beam independently. By emitting the electron beam independently by the emission portion, a beam spot of a certain size may be formed on an anode. When the size of the beam spot needs to be adjusted, a size of the electron beam emitted from the flat cathode may be adjusted by adjusting a count of emission portions that emit the electron beam or redetermining the emission portions that emit the electron beam, so as to adjust a size of the focal point. In addition, a magnitude of a tube current may be switched in real time by adjusting the count of emission portions that emit the electron beam or by adjusting the magnitude of the current from the emission portions. Compared to the prior art where a cathode temperature needs to be adjusted and the focal point size is limited by the performance of a focusing device, the size of the electron beam spot and the magnitude of the current may be switched in real time with a high flexibility in adjustment in the present disclosure.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram of an application scenario of an exemplary system for adjusting a focal point of an X-ray tube according to some embodiments of the present disclosure;

FIG. 2 is a schematic diagram of an exemplary energy-spectrum CT structure according to some embodiments of the present disclosure;

FIG. 3 is a schematic diagram of exemplary modules of an X-ray tube according to some embodiments of the present disclosure;

FIG. 4 is a schematic diagram of an exemplary cathode assembly in an XY plane according to some embodiments of the present disclosure;

FIG. 5 is a cross-sectional view of a cathode of the cathode assembly of FIG. 4 in a YZ plane;

FIG. 6 is a schematic diagram of another exemplary cathode assembly in an XY plane according to some embodiments of the present disclosure;

FIG. 7 is an exemplary cross-sectional view of a cathode of the cathode assembly of FIG. 6 in a YZ-plane;

FIG. 8 is a schematic diagram of an exemplary cathode assembly according to some embodiments of the present disclosure;

FIG. 9 is a schematic diagram of an exemplary flat cathode according to some embodiments of the present disclosure;

FIG. 10 is an exemplary cross-sectional view of a cathode assembly according to some embodiments of the present disclosure;

FIG. 11 is a schematic diagram of exemplary flat cathodes with different shapes according to other embodiments of the present disclosure;

FIG. 12 is a schematic illustration of an exemplary count of flat cathodes according to other embodiments of the present disclosure;

FIG. 13 is a schematic diagram of an exemplary cathode assembly including a fitting hole according to some embodiments of the present disclosure;

FIG. 14 is a schematic diagram of an exemplary fitting hole according to some embodiments of the present disclosure;

FIG. 15 is a schematic diagram of an exemplary fitting hole and an exemplary auxiliary electrode according to some embodiments of the present disclosure;

FIG. 16 is an exemplary cross-sectional view of a cathode assembly including a fitting hole according to some embodiments of the present disclosure;

FIG. 17 is a schematic diagram of an exemplary focusing electrode of a cathode assembly according to some embodiments of the present disclosure;

FIG. 18 is a schematic diagram of an exemplary rectangular focusing electrode according to some embodiments of the present disclosure;

FIG. 19 is a schematic diagram of an exemplary cathode assembly according to some embodiments of the present disclosure;

FIG. 20 is an exemplary cross-sectional view of a cathode assembly including an auxiliary electrode according to some embodiments of the present disclosure;

FIG. 21 is a schematic diagram of an exemplary spherical-like flat cathode according to some embodiments of the present disclosure;

FIG. 22 is a schematic diagram of an exemplary spherical-like flat cathode according to other embodiments of the present disclosure;

FIG. 23 is a schematic diagram of an exemplary cathode assembly including a spherical-like flat cathode according to some embodiments of the present disclosure;

FIG. 24 is an exemplary cross-sectional view of the cathode assembly of FIG. 23 of the present disclosure;

FIG. 25 is a schematic diagram of an exemplary cathode assembly including an auxiliary electrode according to other embodiments of the present disclosure;

FIG. 26 is a schematic diagram of an exemplary flat cathode and an exemplary auxiliary electrode according to some embodiments of the present disclosure;

FIG. 27 is an exemplary cross-sectional view of a cathode assembly and an auxiliary electrode according to some embodiments of the present disclosure;

FIG. 28 is a flowchart of an exemplary process for adjusting a focal point of an X-ray tube according to some embodiments of the present disclosure;

FIG. 29 shows a relationship between a tube current of an X-ray tube and a potential difference between a potential V3 of a cathode adjustment window 216 and a potential V1 of a cathode 212;

FIG. 30 shows a relationship between a cathode emission area and a potential difference between the potential V3 of the cathode adjustment window 216 and the potential V1 of the cathode 212;

FIG. 31 is a schematic diagram of relationships, at different cathode temperatures, between a tube current and a potential difference between a cathode adjustment window and a cathode;

FIG. 32 is a schematic diagram of a relationship between a potential difference and a tube current at a low-voltage tube voltage;

FIG. 33 is a schematic diagram of a relationship between a potential difference and a tube current at a high-voltage tube voltage;

FIG. 34 is a flowchart of an exemplary process for adjusting a focal point of an X-ray tube according to some embodiments of the present disclosure;

FIG. 35 is a schematic diagram of exemplary focal point sizes according to some embodiments of the present disclosure; and

FIG. 36 is a schematic diagram of modules of a system for adjusting a focal point of an X-ray tube according to some embodiments of the present disclosure.

### DETAILED DESCRIPTION

In order to more clearly illustrate the technical solutions relating to the embodiments of the present disclosure, a brief introduction of the drawings referred to the description of the embodiments is provided below. Obviously, the drawings described below are only some examples or embodiments of the present disclosure. Those having ordinary skills in the art, without further creative efforts, may apply the present disclosure to other similar scenarios according to these drawings. Unless obviously obtained from the context or the context illustrates otherwise, the same numeral in the drawings refers to the same structure or operation.

It should be understood that the “system,” “device,” “unit,” and/or “module” used herein are one method to distinguish different components, elements, parts, sections, or assemblies of different levels. However, if other words can achieve the same purpose, the words can be replaced by other expressions.

As used in the disclosure and the appended claims, the singular forms “a,” “an,” and “the” include plural referents unless the content clearly dictates otherwise; the plural forms may be intended to include singular forms as well. In general, the terms “comprise,” “comprises,” and/or “comprising,” “include,” “includes,” and/or “including,” merely prompt to include steps and elements that have been clearly identified, and these steps and elements do not constitute an exclusive listing. The methods or devices may also include other steps or elements.

The flowcharts used in the present disclosure illustrate operations that the system implements according to the embodiment of the present disclosure. It should be understood that the foregoing or following operations may not necessarily be performed exactly in order. Instead, the operations may be processed in reverse order or simultaneously. Besides, one or more other operations may be added to these processes, or one or more operations may be removed from these processes.

X-rays are widely applied in the fields of industrial non-destructive testing, safety inspections, medical diagnosis and treatment, etc. In particular, the X-ray fluoroscopic imaging device made using the high penetrating ability of X-rays plays an important role in all aspects of people's daily life. For example, the computed tomography (CT) device is an advanced high-end application, which obtains high-definition three-dimensional stereo images or slice images. For the existing cathode assembly, a magnitude of a tube current of an X-ray tube is merely adjusted by a cathode temperature. However, due to the thermal inertia of the cathode, the magnitude of the tube current may not be switched in real time. Under the medical imaging needs of various focal point sizes, the adjustment is performed by a focusing device arranged around an electron beam channel, which is limited by the performance of the focusing device, only a fixed count of specific focal point sizes may be adjusted, and results in insufficient flexibility in the complex imaging applications. In summary, the design of the cathode assembly in existing X-ray tubes results in insufficient real-time and flexibility in tube current control and focal point adjustment.

Therefore, the embodiments of the present disclosure provide an X-ray tube, and a method for adjusting a focal point of an X-ray tube, which can be applied in any device where a focal point size needs to be adjusted or fast tube current switching is required. For example, the device may include a Computed Tomography (CT) device, a digital subtraction angiography (DSA) device, a computed radiography (CR) system, a mammography device, etc. In the embodiments of the present disclosure, a typical energy-spectrum CT application is described and explained as an example. In some embodiments, the method for adjusting a focal point disclosed herein may include in response to determining that a current operating tube voltage is smaller than a first tube voltage threshold, adjusting, based on a first potential difference, a divergence angle of an electron beam emitted from a cathode; or in response to determining that the current tube voltage is greater than a second tube voltage threshold, adjusting, based on the first potential difference, a cathode emission area of the electron beam emitted from the cathode. The first tube voltage threshold may be smaller than or equal to the second tube voltage threshold.

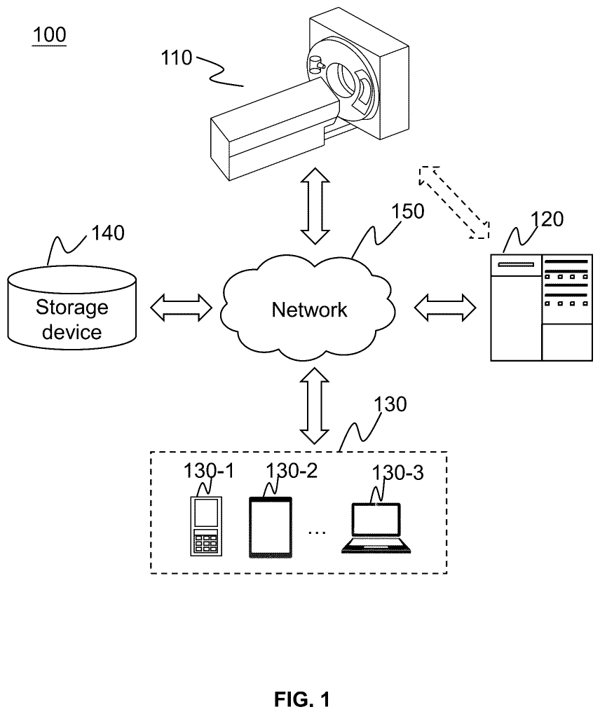

FIG. 1 is a schematic diagram of an application scenario of an exemplary system for adjusting a focal point of an X-ray tube according to some embodiments of the present disclosure.

As shown in FIG. 1, the application scenario 100 of the system for adjusting a focal point of an X-ray tube may include an imaging device 110, a processing device 120, a terminal device 130, a storage device 140, and a network 150. In some embodiments, the processing device 110 may be a portion of the imaging device 110.

The imaging device 110 may be a non-invasive scanning imaging device configured for disease diagnosis or research purposes. The imaging device 110 may obtain, by performing scanning and image reconstruction on a target object, a medical image of the target object. In some embodiments, the imaging device 110 may include a single modality scanner and/or a multi-modality scanner. The single modality scanner may include, for example, an X-ray scanner, a computed tomography (CT) scanner, a digital X-ray radiography (DR) system, etc. The multi-modality scanner may include, for example, an X-ray imaging-magnetic resonance imaging (X-ray-MRI) scanner, a positron emission tomography-X-ray imaging (PET-X-ray) scanner, etc. In some embodiments, the imaging device 110 may include the processing device 120. In some embodiments, the imaging device 110 may include an operation control configured to receive an operation and instruction sent by a user.

The processing device 120 may process data and/or information obtained from the imaging device 110, the terminal device 130, the storage device 140, or other components of the application scenario 100 of the system. For example, the processing device 120 may analyze and process the medical image obtained in the imaging device 110. In some embodiments, the processing device 120 may be local or remote. For example, the processing device 120 may access information and/or data from the imaging device 110, the terminal device 130, and/or the storage device 140 via the network 150.

The terminal device 130 may be a request terminal that performs scanning on the target object. The terminal device 130 may realize an input of the instruction and operation of the user or an output of the medical image. In some embodiments, the user may input a scan request via the terminal device 130. In the present disclosure, the terms “user” and “user terminal” may be used interchangeably. In embodiments of the present disclosure, the terminal device 130 may include a mobile device 130-1, a tablet computer 130-2, a laptop computer 130-3, or the like, or any combination thereof. In some embodiments, the terminal device 130 may be integrated in the imaging device 110, that is, the terminal device 130 and the imaging device 110 may realize all functions as a whole. In the present disclosure, the user may be an operator of the medical device. For example, the user may include a doctor, a researcher, etc.

The storage device 140 may store data, instructions, and/or any other information. In some embodiments, the storage device 140 may store data obtained from the imaging device 110 and/or the processing device 120. For example, the medical image, the operation or instruction sent by the user, etc.

In some embodiments, the storage device 140 may include one or more storage components. Each storage component may be a stand-alone device or may be a portion of other devices. In some embodiments, the storage device 140 may include random access memory (RAM), read-only memory (ROM), mass memory, removable memory, volatile read/write memory, or the like, or any combination thereof. For example, the mass memory may include a disk, an optical disk, a solid-state disk, etc. In some embodiments, the storage device 140 may be implemented on a cloud platform.

The network 150 may include any suitable network that can facilitate exchange of information and/or data. In some embodiments, at least one component (e.g., the imaging device 110, the processing device 120, the terminal device 130, or the storage device 140) of the application scenario 100 of the system for adjusting a focal point of an X-ray tube may exchange information and/or data with at least one other component of the application scenario 100 of the system via the network 150. For example, the processing device 120 may obtain the medical image of the target object from the imaging device 110 via the network 150.

It should be noted that the application scenario 100 of the system for adjusting a focal point of an X-ray tube is merely provided for the purpose of illustration, and not intended to limit the scope of the present disclosure. For those skilled in the art, various modifications or variations may be made according to the descriptions of the present disclosure. For example, the application scenario 100 of the system for adjusting a focal point of an X-ray tube may also include a database. As another example, the application scenario 100 of the system for adjusting a focal point of an X-ray tube may achieve similar or different functions on other devices. However, these variations and modifications do not depart from the scope of the present disclosure.

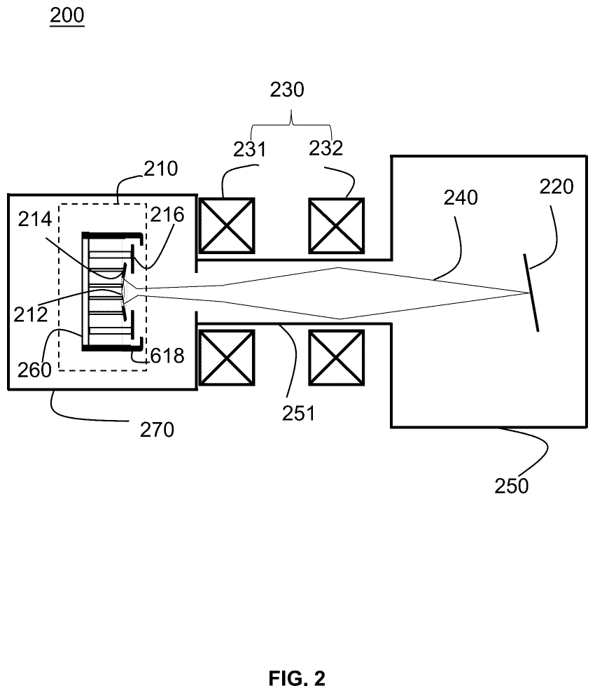

FIG. 2 is a schematic diagram of an exemplary energy-spectrum CT structure according to some embodiments of the present disclosure.

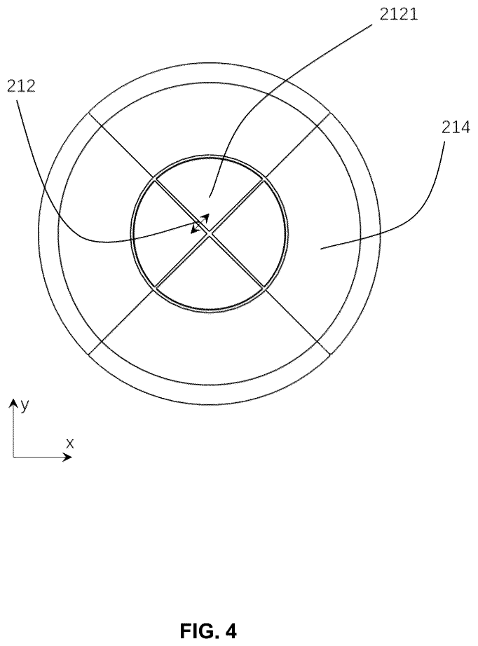

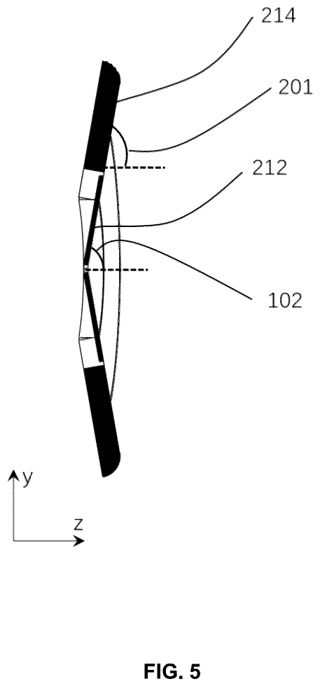

The energy-spectrum CT structure shown in FIG. 2 may include an X-ray tube (i.e., a bulb tube). The X-ray tube may include a cathode assembly 210 (e.g., the cathode assembly of the X-ray tube shown in FIGS. 4A, 4B, 5A, and 5B), an anode assembly 220, and a focusing deflection structure 230. The X-ray tube refers to a vacuum electronic device that generates X-rays using high-speed electrons to hit a metal target surface, which may be commonly used in medical equipment.

In some embodiments, the cathode assembly 210 may include a cathode 212, a focusing electrode 214, a cathode adjustment window 216, and an electric field shielding ring 618. The anode assembly 220 may include a target disk. In some embodiments, the cathode may also be referred to as a flat cathode, which may be used interchangeably.

The energy-spectrum CT structure may also include a ceramic 260, a vacuum chamber wall 270, and a beam pipe 251 (also referred to as a pipe 251). The focusing deflection structure 230 may include a magnetron unit 231 and a magnetron unit 232

Each portion of the cathode assembly may be insulated from each other by the ceramic 260, thereby ensuring insulation and connection. The vacuum chamber wall 270 may be configured to isolate the energy-spectrum CT from the external environment. A potential of the vacuum chamber wall 270 may be generally 0. An electron beam 240 emitted by the cathode assembly may be received by the target disk. The target disk may be configured to generate X-rays. In some embodiments, the target disk may be a rotatable target disk or a stationary target disk.

The magnetron units 231 and 232 may focus the electrons emitted from the cathode assembly. The magnetron units 231 and 232 may be disposed between the cathode assembly and the anode assembly, and the magnetron units 231 and 232 may be spaced from both the cathode assembly and the anode assembly. In some embodiments, the magnetron units 231 and 232 may be quadrupole magnets, guiding magnets, etc. In some embodiments, other than disposing of the two magnetron units 231 and 232, only one magnetron unit or more than two magnetron units may be disposed. In some embodiments, the magnetron unit may also be a beam optical element (e.g., a solenoid), or a combination between different magnetic focusing elements, and the magnetic focusing structure may also be replaced by an electrical focusing structure.

In some focal point adjustment manners, a focal point size may be adjusted by adjusting a current of the quadruple magnet. However, it is often difficult to obtain a relatively small focal point due to the limited spatial resolution of the energy-spectrum CT structure. Specifically, due to the Pierce structure in the cathode assembly, emittance of electrons may increase greatly, and divergence of electrons may be very severe. On the one hand, the focusing force that needs to be provided by the magnetic focusing element may be increased, and on the other hand, a size of the beam pipe 251 may be increased, so that the X-ray tube structure may be no longer compact. When a first quadrupole magnet (e.g., the magnetron unit 231) focuses the electrons in one direction, the electrons in another direction perpendicular to the direction may diverge, which may make the electron beam that is already heavily divergent continue to diverge, and the beam pipe 251 may be further enlarged.

In the embodiments of the present disclosure, a cathode emission area may be regulated by adjusting a potential difference between the cathode emission area and the cathode. Without increasing the current of the magnetic focusing element and the size of the beam pipeline, the focus size may be regulated from ultra-large to ultra-small, allowing the energy spectrum CT to achieve the unity of high temporal resolution and high spatial resolution. Merely by way of example, when the focal point size is large enough, scanning may be performed on a site (e.g., heart, etc.) in a very short time (e.g., within a breath) to cope with the high temporal resolution (a complete organ may be seen with a large field of view of the radiation). The focal point may be adjusted to a small enough size (e.g., small focus of a blood vessel and a tiny lesion) to cope with clinical needs that require the ultra-high spatial resolution (a small but clearer field of view), such as radiotherapy.

In some embodiments, the anode assembly 220 and the cathode assembly 210 may be spaced apart along an emission direction of the electron beam 240, and the focusing deflection structure 230 may be provided between the anode assembly 220 and the cathode assembly 210. The focusing deflection structure 230 may be configured to cooperate with the focusing electrode 214 to focus the electron beam 240 emitted from the flat cathode 212 onto the anode assembly 220.

In some embodiments, the focusing deflection structure 230 in cooperation with the focusing electrode 214 enables focusing of the electron beam 240, so that a change in a potential of the focusing electrode 214 may not affect the focusing of the electron beam 240 on the anode assembly 220, thereby improving an adjustable range of the potential of the focusing electrode 214 and improving reliability and adaptability of the X-ray tube.

The focusing deflection structure 230 may be formed by an electric field or a magnetic field. In some embodiments, if the focusing deflection structure 230 is a magnetic field structure, the focusing deflection structure 230 may further shape a beam spot, and may further include a guiding magnet for focus shift of the beam spot. If the focusing deflection structure 230 is an electric field structure, the focusing of the beam spot may be accomplished by designing a metal structure with a certain shape and voltage distribution. By independently controlling current emissions of the four arc-shapes flat cathodes and combining different counts of the arc-shaped flat cathodes, it is possible to achieve the switching between at least four different focal point sizes with the assistance of a quadrupole magnet.

In some embodiments, the target disk may include a first plane and a second plane (not shown in FIG. 2) that are sequentially arranged. The second plane may be configured to surround an outer side of the first plane in a circumferential direction, and form a preset inclination angle with the first plane. The electron beam emitted by the cathode assembly may be focused on the second plane.

In some embodiments, the second plane may form the preset inclination angle with the first plane to perform line-focused projection on the electron beam, and the preset inclination angle may be generally in a range of 7°-10°. The electron beam 240 may bombard an edge (i.e., the second plane) of the target disk to generate X-rays for diagnostic medical imaging.

In some embodiments, the X-ray tube may further include a tube core 250 and a bearing (not shown). The bearing may be mounted on the tube core 250 and the bearing may be connected to the target disk. The bearing may be configured to rotate to drive the target disk to rotate around a centerline of the first plane.

Specifically, the cathode assembly and the target disk may be mounted inside the tube core, and the bearing may be configured to drive the target disk to rotate around the centerline of the first plane to dissipate heat from the target disk. The tube core may be generally made of metal, ceramic, or glass to ensure that an interior of the X-ray tube is in a vacuum environment.

Further, the tube core 250 may have the pipe 251 within the tube core 250 that corresponds to the second plane. The pipe 251 may be the beam pipe of the electron beam. An inlet of the pipe 251 may be located between the anode assembly 220 and the cathode assembly 210. The focusing deflection structure 230 may be located on two sides of the inlet of the pipe 251, so that the electron beam 240 emitted by the cathode assembly 210 may enter the pipe 251 through the inlet of the pipe 251 with the cooperation of the focusing electrode 214 and the focusing deflection structure 230, and hit the second plane of the target disk. The pipe 251 may be provided to block a portion of the electron beam away from a center of the focal point, thereby reducing interference with the focal point on the target disk.

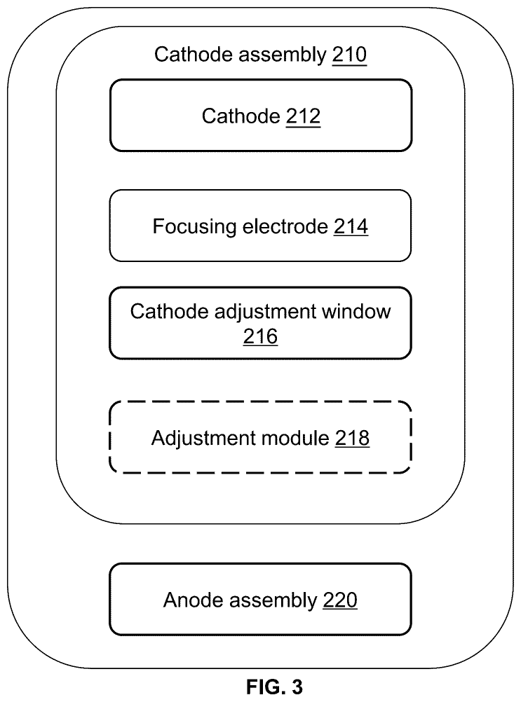

FIG. 3 is a schematic diagram of exemplary modules of an X-ray tube according to some embodiments of the present disclosure. In some embodiments, the x-ray tube may include the cathode assembly 210 and the anode assembly 220.

The cathode assembly 210 may be configured to generate and emit an electron beam.

In some embodiments, the cathode assembly 210 may include the cathode 212. The cathode 212 refers to a component of the cathode assembly of the X-ray tube configured to generate and emit the electron beam. The basic principle of the X-ray tube may be that the cathode emits electrons by heating the cathode, the electrons are accelerated by a high voltage and hit an anode target disk, and X-rays are generated. The cathode 212 refers to a key component of the X-ray tube, which generates the X-rays by providing a stable, concentrated, and efficient source of electrons.

In some embodiments, the cathode assembly 210 may include the cathode 212. The cathode 212 may be circular or elliptical. Merely by way of example, the cathode 212 may also be rectangular, etc. Preferably, the cathode 212 may be a circular structure (i.e., a circular cathode).

In some embodiments, the cathode 212 may be a one-piece structure. For example, the cathode 212 may be a Pierce cathode.

In some embodiments, the cathode may include a plurality of cathode portions, and the composed cathode may be circular, elliptical, rectangular, etc. A count of cathode portions may be 2, 3, 4, 5, etc. A surface of the cathode portion may be planar, cambered, etc. For example, the cathode portion may include a flat portion, a cambered portion, etc. The projection of the cathode portion in a direction perpendicular to the surface of the cathode portion may be a rectangle, a sector, a triangle, etc. Preferably, the projection of the cathode portion in a direction perpendicular to the surface of the cathode portion may be the sector, so that the cathode may be the circular cathode. More preferably, the projection of the cathode portion in a direction perpendicular to the surface of the cathode portion may be the sector and the surface of the cathode portion may be planar, so that the cathode may be an arc-shaped flat cathode portion. In some embodiments, a gap between two adjacent cathode portions may be smaller than a certain threshold, so that the electron beams emitted by the two adjacent cathode portions may be distributed evenly in the gap between the two adjacent cathode portions, and may be distributed in the two adjacent cathode portions. In some embodiments, the gap between the two adjacent cathode portions may be determined according to a cathode angle and the focal point size. For example, the gap between the two adjacent cathode portions may be in a range of 50 micrometers-2 millimeters. As another example, the gap between the two adjacent cathode portions may be in a range of 10 micrometers-50 micrometers.

In some embodiments, the cathode and the focusing electrode may respectively form an angle with a direction of a central axis. The cathode and the focusing electrode may form equal angles or different angles with the direction of the central axis. In some embodiments, the angles formed by the cathode and the focusing electrode with the direction of the central axis may be in a range of 10 degrees-30 degrees. In some embodiments, the angles formed by the cathode and the focusing electrode with the direction of the central axis may be in a range of 10 degrees-60 degrees. The central axis refers to an axis perpendicular to a plane in which the cathode assembly 210 is located.

The focusing electrode 214 may be configured to focus the emitted electrons to form the electron beam. The focusing electrode may be a Pierce focusing electrode, an electrostatic lens, such as a cylindrical electrode, a multi-diaphragm electrode, etc. The cathode assembly of the X-ray tube may be configured to adjust the focal point of the X-ray tube by adjusting a potential difference between a cathode adjustment window and the cathode according to a first focal point size.

Preferably, the cathode may include the circular cathode including the plurality of cathode portions, so that the cathode may resemble a spherical structure, that is, a structure similar to a spherical Pierce cathode may be formed. The structure of the approximate spherical Pierce cathode may make the emitted electron beam spots evenly distributed, and match a larger target angle at a same radiation power, so that the field of view of the radiation may be larger, and a field of view at a large focal point may cover an entire organ. Full scanning of the organ may be completed with high temporal resolution with only one-circle rotation of a gantry.

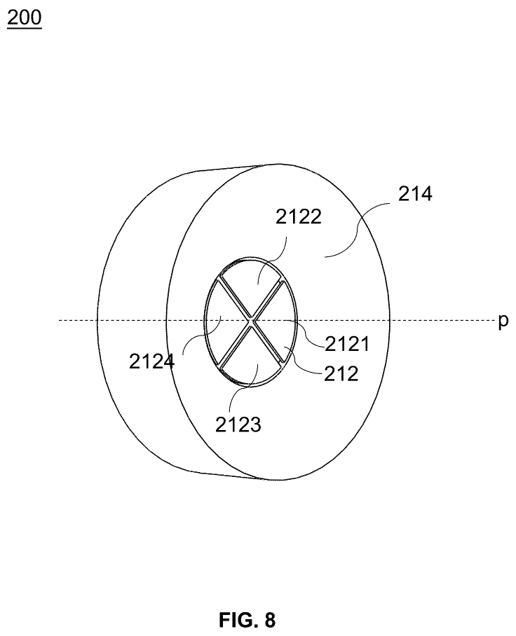

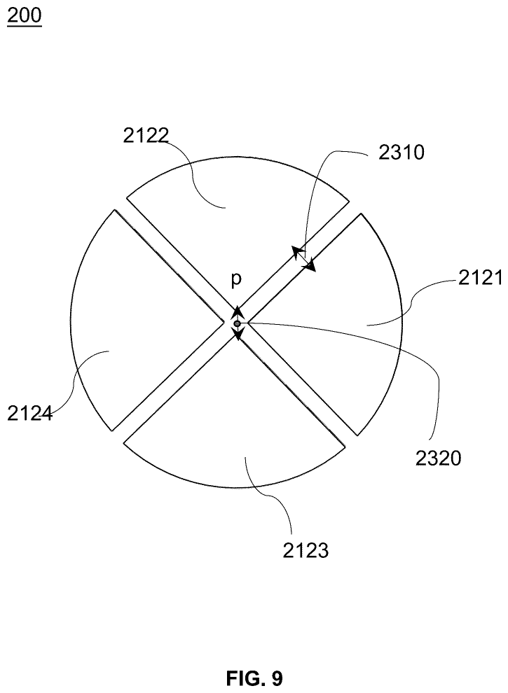

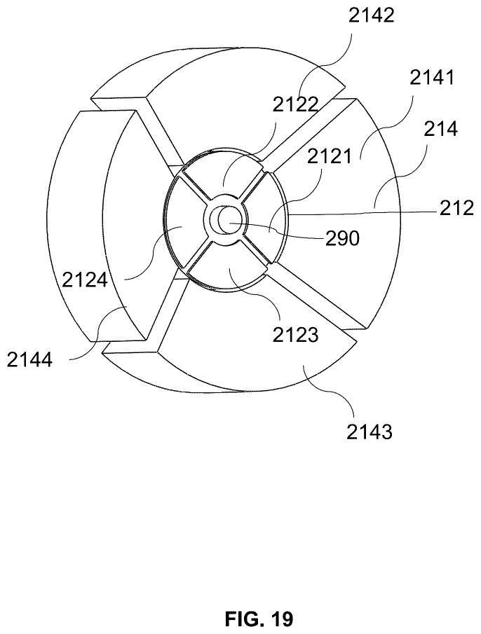

In some embodiments, the cathode may include four cathode portions. Each cathode portion may also be referred to as an emission portion. More descriptions regarding the emission portion may be found in the descriptions of FIG. 8, FIG. 9, and FIG. 19 below.

In some embodiments, the cathode may include a circular cathode with four cathode portions. The circular cathode including the four cathode portions is described and explained below as an example. For example, the cathode assembly of an X-ray tube may be as shown in FIG. 4 and FIG. 5. FIG. 4 is a schematic diagram of an exemplary cathode assembly in an XY plane according to some embodiments of the present disclosure. The cathode 212 may include four arc-shaped cathode portions, and the separated four cathode portions may form the integral cathode 212. There may be a gap between the four cathode portions. The focusing electrode 214 may be a Pierce focusing electrode. A combination of the circular cathode and the Pierce focusing electrode may result in an even distribution of beam spots formed by the emitted electron beam.

FIG. 5 is a cross-sectional view of a cathode of the cathode assembly of FIG. 4 in a YZ plane. Four cathode portions may respectively form an angle 102 with a direction of a central axis, and the angle 102 may be an acute angle. Each of the four cathode portions has an emission surface. The emission surface is a surface from which the cathode portion emits electrons. A first angle (e.g., the angle 102) is formed between the emission surface and the direction of the normal vector of the central axis of the X-ray tube. The angle 102 may be acute. Therefore, the four flat cathodes may form a spherical-like structure, that is, a structure similar to a spherical Pierce cathode may be formed. The focusing electrode 414 may also form an angle 201 with the direction of the central axis to ensure laminar emission of the emitted electron beam. The focusing electrode has a focusing surface. In some embodiments, the orientation of the focusing surface may be the same as the emission surface of the cathode portion. In some embodiments, the focusing surface and the emitting surface in the same radial direction are in the same plane or parallel to each other. The orientations of different emitting parts and their corresponding focusing surfaces can be different. A second angle (e.g., the angle 201) is formed between the focus surface and the direction of the normal vector of the central axis of the X-ray tube. The angle 201 may be acute. The central axis is the Z-axis, and the angle 102 between the cathode 412 and the central axis and the angle 201 between the focusing electrode 414 and the central axis may be the same. In some embodiments, the first angle may also be referred to as a first acute angle and the second angle may also be referred to as a second acute angle.

According to FIG. 4 and FIG. 5, the circular cathode 412 may be surrounded by a structure that adjusts emittance of the electron beam emitted from the cathode, which may adjust a divergence angle of the emitted electron beam and/or a cathode emission area. In addition, the circular cathode 412 may have a strong regulation ability, and when a same length (or width) is reduced or increased, the circular cathode emission area may change more than the cathode emission area of other shapes, and the adjustable area may be large, so that the focal point size may be adjusted in a larger range. The length and width directions of the circular cathode emission area may be changed in a same proportion, so that a focusing ratio and/or an aspect ratio may be maintained when the cathode emission area is adjusted. Therefore, compared to the cathodes 412 of other shapes, the best result is achieved when the cathode 412 is circular and the method for adjusting a focal point of an X-ray tube described herein is implemented.

In some embodiments, the cathode assembly 210 may also include the cathode adjustment window 216.

The cathode adjustment window 216 may be configured to adjust the emittance of the electron beam emitted from the cathode 212. The emittance of the electron beam emitted from the cathode 212 refers to a parameter that measures a divergence degree of the electron beams. The emittance of the electron beam emitted from the cathode 212 may be related to the divergence angle of the electron beam emitted from the cathode 212 and the cathode emission area. For example, the emittance of the electron beam emitted from the cathode 212 may be equal to a product of the divergence angle of the electron beam emitted from the cathode 212 and the cathode emission area. As described herein, the divergence angle of the electron beam emitted from the cathode 212 refers to an angle of divergence of the emitted electron beam, and the cathode emission area refers to an area of an effective area where electrons are extracted from the cathode. The size of the focal point formed at the anode of the X-ray tube may be related to the emittance of the electron beam emitted from the cathode 212, that is, the size of the focal point formed at the anode of the X-ray tube may be related to the divergence angle of the electron beam emitted from the cathode and the cathode emission area. The smaller the divergence angle of the electron beam or the smaller the cathode emission area, the smaller the emittance of the electron beam emitted from the cathode 212, and the smaller the focal point that can be realized at the anode. Conversely, the larger the divergence angle of the electron beam or the larger the cathode emission area, the larger the emittance of the electron beam emitted from the cathode, and the larger the focal point that can be realized at the anode. A total area of an actual structure of the cathode may be an initial cathode emission area. The cathode emission area may be adjusted through the cathode adjustment window 216 according to a desired focal point size. The divergence angle of the electron beam emitted from the cathode 212 may also be adjusted through the cathode adjustment window 216 according to the desired focal point size.

The cathode adjustment window 216 may be made of conductive materials, for example, metallic materials, etc. In some embodiments, the cathode adjustment window 216 may include a plurality of tube current extraction electrodes.

The cathode adjustment window 216 may be disposed at a periphery of the cathode. In some embodiments, the cathode adjustment window 216 may be disposed at an entire region of the periphery of the cathode 212 and enclose the periphery of the cathode 212. That is, the cathode adjustment window 216 may be disposed around the periphery of the cathode 212. For example, the cathode adjustment window 216 may be an annular flat plate. When the cathode adjustment window 216 is disposed around the cathode 212, any ray extending along a direction of a length of the cathode, a direction of a width of the cathode, or a direction of a radius of the cathode may pass through the cathode adjustment window 216. A radius (or equivalent radius) of the cathode adjustment window 216 may be greater than the radius (or equivalent radius) of the cathode. The cathode adjustment window 216 may be disposed around the cathode 212. A projection region of the cathode adjustment window 216 in a plane perpendicular to the central axis along the direction of central axis may enclose a projection region of the cathode in the plane along the central axis.

In some embodiments, the cathode adjustment window 216 may be disposed at a partial region of the periphery (or surrounding) of the cathode. When the cathode adjustment window is disposed at the partial region of the periphery of the cathode, at least one ray extending along the direction of the length of the cathode, the direction of the width of the cathode, or the direction of the radius of the cathode may not pass through the cathode adjustment window 216. The radius (or equivalent radius) of the cathode adjustment window 216 may be greater than the radius (or equivalent radius) of the cathode. The cathode adjustment window 216 may be disposed at the partial region of the surrounding of the cathode 212. The projection region of the cathode adjustment window 216 in a plane perpendicular to the central axis along the direction of the central axis may not enclose the projection region of the cathode in the plane along the central axis.

In some embodiments, the cathode assembly 210 may further include an adjustment module 218 (e.g., a controller or a processor). The adjustment module 218 may be configured to adjust emittance of the electron beams emitted from the cathode at different tube voltages by adjusting, based on a target focal point size, a potential difference between the cathode adjustment window and the cathode, and/or by adjusting a voltage of at least one of the cathode adjustment window and the cathode, so that a size of the electron beam spot formed by the electron beam matches the target focal point size.

In some embodiments, the adjustment module 218 may be a control module of the X-ray tube.

The potential difference between the cathode adjustment window and the cathode refers to a result of subtracting a potential of the cathode from a potential of the cathode adjustment window, which may be positive or negative.

At a relatively low tube voltage, for example, when the tube voltage is less than a first tube voltage threshold (e.g., 110 kV, 120 kV), there may be no way for the electrons of the cathode to be fully emitted, so the potential of the cathode adjustment window 216 may be higher than the potential of the cathode 212, and the potential difference may be formed between the cathode adjustment window 216 and the cathode 212. At this time, the potential difference may be positive. A divergence angle of the electron beam emitted from the cathode may be adjusted by adjusting the potential difference between the cathode adjustment window 216 and the cathode 212, and a focal point of a specific size may be obtained. There may also be a correspondence between the divergence angle of the electron beam and the potential difference between the cathode potentials.

In some embodiments, at a relatively high tube voltage, for example, when the tube voltage is greater than a second tube voltage threshold (e.g., 120 kV), the potential of the cathode adjustment window 216 may be lower than the potential of the cathode 212, so that the potential difference may be formed between the cathode adjustment window 216 and the cathode 212. At this time, the potential difference may be negative, and the cathode adjustment window 216 may adjust the cathode emission area by adjusting the potential difference between the cathode adjustment window and the cathode to obtain a focal point of a specific size. There is a correspondence between the cathode emission area and the potential difference between the cathode adjustment window 216 and the cathode 212. The smaller the potential difference between the cathode adjustment window 216 and the cathode 212, the larger the cathode emission area.

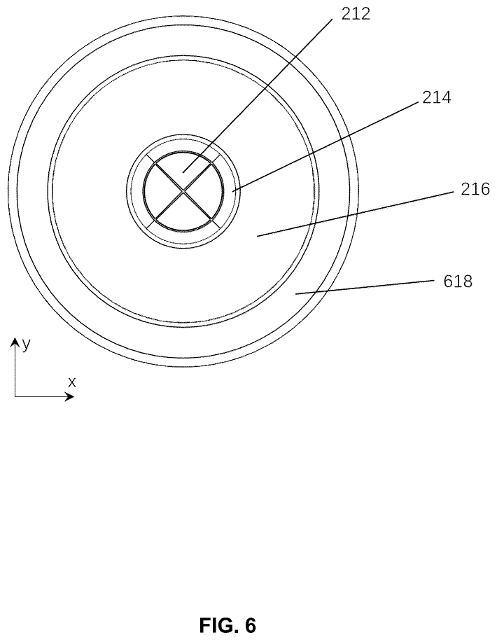

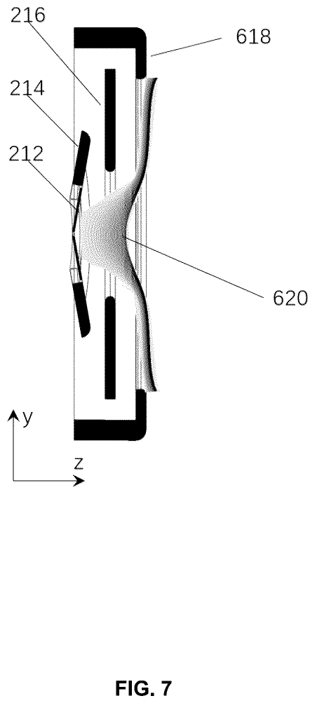

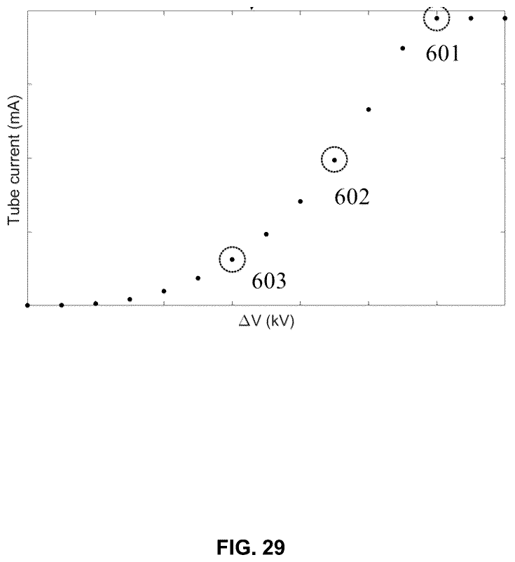

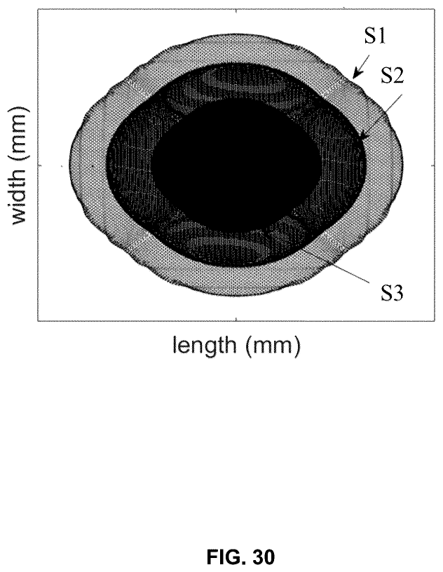

More descriptions regarding the potential difference between the cathode adjustment window and the cathode may be found in FIG. 6, FIG. 7, FIG. 29, and FIG. 30.

In the embodiments of the present disclosure, the divergence angle and/or the cathode emission area of the electron beam emitted from the cathode may be adjusted according to the desired focal point size (e.g., a target focal point size), which may dynamically adjust the divergence of the emitted electron beam without a change in an area of the cathode assembly and without the need to install a plurality of cathodes of different sizes for switching to achieve a change in the focal point size.

In some embodiments, the correspondence between the cathode emission area and the potential difference between the cathode adjustment window and the cathode may be stored in a storage in the form of a table, function, model, etc. In some embodiments, the correspondence between the divergence angle of the electron beam and the potential difference between the cathode potentials may also be stored in the storage in the form of a table, a function, a model, etc.

In some embodiments, the cathode assembly 210 may also include an electric field shielding ring. The electric field shielding ring may make an electric field of the cathode assembly more uniform. The electric field shielding ring may be annular and made of metallic materials. In some embodiments, the electric field shielding ring may be disposed at a periphery of the cathode adjustment window 216. For example, the electric field shielding ring may enclose the periphery of the cathode adjustment window 216. That is, the electric field shielding ring may be disposed at an entire region of the periphery of the cathode adjustment window 216. In some embodiments, the electric field shielding ring may be disposed at a partial region of the periphery of the cathode adjustment window 216. A radius (or equivalent radius) of the electric field shielding ring may be greater than the radius (or equivalent radius) of the cathode adjustment window 216. The electric field shielding ring may be disposed around the cathode adjustment window 216. A projection region of the electric field shielding ring in a plane perpendicular to the central axis along the direction of the central axis may enclose a projection region of the cathode adjustment window 216 in the plane along the central axis.

For example, as shown in FIG. 6 and FIG. 7, FIG. 6 is a schematic diagram of another exemplary cathode assembly in an XY plane according to some embodiments of the present disclosure, and FIG. 7 is an exemplary cross-sectional view of a cathode of the cathode assembly of FIG. 6 in a YZ plane. In contrast to the cathode assembly shown in FIG. 4 and FIG. 5, the cathode assembly illustrated in FIG. 6 and FIG. 7 may also include the cathode adjustment window 216 and the electric field shielding ring (e.g., electric field shielding ring 618). The electric field shielding ring 618 may be disposed around the cathode adjustment window 216, and the cathode adjustment window 216 may be disposed around the cathode 212. The focusing electrode 214 may be disposed around the cathode 212. The electric field shielding ring 618 may make an electric field of the cathode assembly more uniform.

As shown in FIG. 6 and FIG. 7, a potential of the cathode 212 may be denoted as V1, a potential of the focusing electrode 214 may be denoted as V2, a potential of the cathode adjustment window 216 may be denoted as V3, and a potential of the electric field shielding ring 618 may be denoted as V4. The potential V4 of the electric field shielding ring 618 may be equal to any of V1, V2, and V3. For example, the potential V4 of the electric field shielding ring 618 may be equal to the potential V2 of the focusing electrode 214 for convenience in practice. The relatively small potential difference between the potential V2 of the focusing electrode 214 and the potential V1 of the cathode 212 may be configured to regulate the electric field distribution of the cathode assembly. The potential distribution of the cathode assembly is shown as 620 in FIG. 7.

In some embodiments, the potential difference between the cathode adjustment window 216 and the cathode 212 may be adjusted by changing the potential V3 of the cathode adjustment window 216. In some embodiments, the potential difference between the cathode adjustment window 216 and the cathode 212 may also be adjusted by changing the potential V1 of the cathode 212.

When at a relatively high tube voltage (i.e., greater than the second tube voltage threshold), since the potential V3 of the cathode adjustment window 216 is lower than the potential V1 of the cathode 212, the potential difference between V3 and V1 may be negative, and the greater the potential difference, the greater the tube current emitted by the cathode assembly, so that the tube current of the X-ray tube may be adjusted, and the tube current switching at a microsecond level may be realized. Since a voltage adjustment speed of a grid electrode is in a microsecond range and a switching speed between voltages is in a microsecond range, a single switching of the tube current may take only a few microseconds, resulting in a fast tube current switching. When at a relatively low tube voltage (i.e., less than the second tube voltage threshold), since the potential V3 of the cathode adjustment window 216 is higher than the potential V1 of the cathode 212, the potential difference between V3 and V1 may be positive, and the greater the potential difference, the smaller the divergence angle of the emitted electron beam until the divergence angle approaches zero. The divergence angle of the electron beam or the cathode emission area may be adjusted by adjusting the potential difference between the cathode adjustment window 216 and the cathode 212, thereby realizing the adjustment of the focal point size, and obtaining a focal point of an arbitrary size.

In some embodiments of the present disclosure, the X-ray tube may include the cathode and the cathode adjustment window. The cathode may be configured to emit the electron beam, and the cathode adjustment window may be disposed at the periphery of the cathode. By obtaining a target focal point size of the X-ray tube, emittance of the electron beams emitted from the cathode at different tube voltages may be adjusted by adjusting, based on a target focal point size, the potential difference between the cathode adjustment window and the cathode, so that a size of an electron beam spot may match the target focal point size, thereby realizing fast tube current switching and adjustment of the focal point size.

FIG. 8 is a schematic diagram of an exemplary cathode assembly according to some embodiments of the present disclosure. As shown in FIG. 8, the cathode assembly 210 may include the flat cathode 212 and the focusing electrode 214.

The flat cathode 212 may include at least two emission portions each of which is configured to independently emit an electron beam, and the at least two emission portions may be arranged around a center of the flat cathode 212.

The flat cathode refers to a component of the cathode assembly of an X-ray tube that is configured to generate an electron beam. The basic principle of the X-ray tube may be that the cathode emits electrons by heating the cathode, the electrons are accelerated by a high voltage and hit an anode target disk, and X-rays are generated. The flat cathode refers to a key component of the X-ray tube, which generates the X-rays by providing a stable, concentrated, and efficient source of electrons.

The emission portion refers to a component of the flat cathode 212 configured to emit electrons. In some embodiments, a count of the at least two emission portions may be 2, 3, 4, 5, etc. Preferably, the count of the at least two emission portions may be an even number, and the even number of emission portions may be disposed symmetrically around the center of the flat cathode. For example, FIG. 2 shows the flat cathode 212 including four emission portions. Each 90°-angled sector denotes an emission portion, and one or more cathode sheets may be included within an emission portion. For example, the flat cathode 212 may include an emission portion 2121, an emission portion 2122, an emission portion 2123, and an emission portion 2124.

In some embodiments, each of the at least two emission portions may be configured to independently emit the electron beam. In other words, a current of each emission portion may be controlled independently. Independent emission means that each emission portion does not interfere with each other when emitting the electron beam, e.g., the at least two emission portions may emit the electron beams at the same time, or some of the at least two emission portions may emit the electron beams, and the emission portion that does not emit the electron beam does not affect a normal operation of the emission portion that emits the electron beam. In some embodiments, the emission portion 2121, the emission portion 2122, the emission portion 2123, and the emission portion 2124 may emit the electron beams in any combination. For example, the emission portion 2121 and the emission portion 2124 may emit electron beams, while the emission portion 2122 and the emission portion 2123 may not emit electron beams. As another example, the emission portion 2121 may emit electron beam, while the emission portion 2122, the emission portion 2123, and the emission portion 2124 may not emit electron beams.

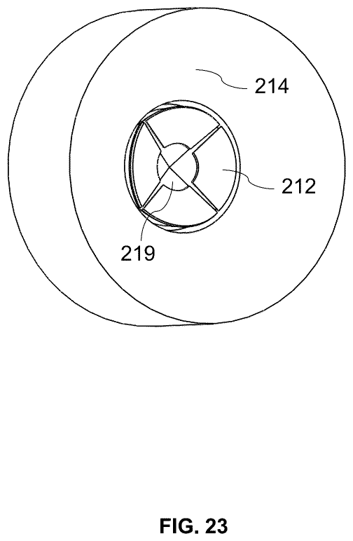

Understandably, selecting different emission portions to emit the electron beams may result in variations in a count and a position of emitted electron beam(s), which may result in difference in a size and a position of a beam spot (i.e., a focal point) formed on an anode (see FIGS. 23 to 26). For the beam spot formed by the electron beam on the anode, when a size of the beam spot needs to be adjusted, the electron beams emitted by the flat cathode may be adjusted by changing the count and the position of the emission portion(s) emitting the electron beams, or reconfiguring the emission portions that are required to emit the electron beams, and the size of the focal point may be adjusted.

Merely by way of example, if an ultra-small focal point is required, only one of the four emission portions may be configured to emit the electron beam. If a small focal point is required, any two of the four emission portions may be configured to independently emit an electron beam, respectively. If a large focal point is required, any three of the four emission portions may be configured to independently emit an electron beam, respectively. If an ultra-large focal point is required, all four emission portions may be configured to emit electron beams simultaneously. This emission configuration may result in a small difference in the current amplitude of each emission portion, thereby increasing a service life of the flat cathode 212. In addition, by configuring a smaller count of emission portions to emit electron beams when a relatively small focal point is required and configuring a larger count of emission portions to emit electron beams when a relatively large focal point is required, on one hand, a continuous change from an ultra-small focal point to an ultra-large focal point can be achieved, thereby improving an adaptability of the X-ray tube, on the other hand, the difference in required current amplitude can be minimized, thereby improving a stability of the electron beams. Moreover, by configuring each of the at least two emission portions to independent emit electron beams, if a single or some of the at least two emission portions fail(s), other emission portion(s) or combination(s) of emission portion(s) may be used as replacements, ensuring continuity of performance.

In some embodiments, the at least two emission portions may be arranged around the center of the flat cathode. The center may be a geometric center of the flat cathode, for example, the center may be a location crossed by the central axis P in FIG. 8.

Exemplarily, the emission portion 2121, the emission portion 2122, the emission portion 2123, and the emission portion 2124 may be arranged in a circumferential direction around the geometric central axis p of the flat cathode.

In some embodiments, adjacent edges of any two emission portions of the at least two emission portions may be parallel. FIG. 9 is a schematic diagram of an exemplary flat cathode according to some embodiments of the present disclosure. As shown in FIG. 9, adjacent edges of any two emission portions (e.g., the emission portion 2121 and the emission portion 2122, the emission portion 2123 and the emission portion 2124, the emission portion 2124 and the emission portion 2123, or the emission portion 2123 and the emission portion 2121) may be parallel. The adjacent edges refer to neighboring edges or two edges that are closest in position of two adjacent emission portions. In this embodiment, the adjacent edges of any two adjacent emission portions may be parallel, and there may be a gap between the adjacent emission portions. The gap may assist in heat dissipation of a cathode sheet.

In some embodiments, each of the at least two emission portions may include at least one cathode sheet. For example, an emission portion may include one cathode sheet or may include two or more cathode sheets. Understandably, one cathode sheet may constitute an emission portion, or two or more cathode sheets may constitute an emission portion, which is not limited by this embodiment.

In some embodiments, the cathode sheet may be made of a metal material or an alloy material. For example, the cathode sheet may be made of tungsten, niobium, or a material doped with a certain percentage of tungsten, etc. In some embodiments, the cathode sheet may include an emission surface. The emission surface refers to a surface of the cathode sheet where electrons are generated.

In some embodiments, the flat cathode may also be a thin film cathode. The thin film cathode may be laid flat directly on a base of the cathode assembly.

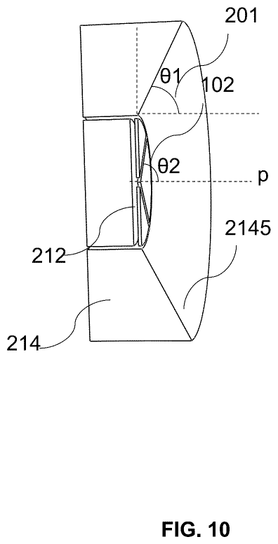

In some embodiments, the emission surface of the at least one cathode sheet may form the second acute angle 102 with the central axis of the flat cathode. More descriptions regarding the second acute angle may be found in FIG. 10 and the relevant descriptions thereof.

FIG. 10 is an exemplary cross-sectional view of a cathode assembly according to some embodiments of the present disclosure.

In some embodiments, an emission surface of the at least one cathode sheet may form a second acute angle with a central axis of a flat cathode. In FIG. 10, a surface of the cathode sheet facing the central axis direction p of the flat cathode is the emission surface of the cathode sheet. When there are a plurality of cathode sheets, each of the plurality of cathode sheets may have an emission surface.

The second acute angle refers to an angle between the emission surface of the at least one cathode sheet and the central axis of the flat cathode.

In some embodiments, the second acute angle may be in a range of 45°≤θ2≤86°. For example, the second acute angle 102 may be 45°, 50°, 60°, 70°, 80°, 86°, etc.

In some embodiments, the angle between the emission surface of the at least one cathode sheet and the central axis of the flat cathode may also be 90° (e.g., θ2 in FIG. 10) At this time, a surface of the cathode sheet is perpendicular to the central axis p.

In some embodiments, angles between at least one cathode sheet included in each emission portion and the central axis of the flat cathode may be equal. For example, each of the four cathode sheets may be at the second acute angle 102 to the central axis p of the flat cathode. It may be understood that the smaller the second acute angle 102 is, the greater the focusing intensity may be.

In some embodiments, by setting θ2 to be in a range of greater than or equal to 45° and smaller than or equal to 86°, the flat cathode of the entire X-ray tube may form a spherical-like structure, which may cause the entire cathode assembly to be an approximately spherical Pierce cathode gun, thereby improving the uniformity of the beam spot of the electron beam and extending the service life of the X-ray tube target disk.

In some embodiments, the angle θ2 between the flat cathode of the X-ray tube and the central axis p of the flat cathode may be 45°. In some embodiments, the angle θ1 between the flat cathode of the X-ray tube and the central axis p of the flat cathode may be 86°. In some embodiments, the angle θ2 between the flat cathode of the X-ray tube and the central axis p of the flat cathode may be 50°. In some embodiments, the angle θ1 between the flat cathode of the X-ray tube and the central axis p of the flat cathode may be 70°.

In some embodiments, the angle θ2 between the flat cathode of the cathode assembly of the X-ray tube and the central axis p of the flat cathode may also be in a range of 60°≤θ2≤80°. By setting θ2 to be in a range greater than or equal to 60° and smaller than or equal to 80°, the flat cathode of the entire X-ray tube may form a spherical-like structure, which may make the entire cathode assembly an approximately spherical Pierce cathode gun, thereby improving the uniformity of beam spot of the electron beam 140 and extending the service life of the X-ray tube target disk.

In some embodiments, the angle θ2 between the flat cathode of the X-ray tube and the central axis p of the flat cathode may be 60°. In some embodiments, the angle θ2 between the flat cathode 100 of the X-ray tube and the central axis p of the flat cathode 100 may be 80°. In some embodiments, the angle θ2 between the flat cathode 100 of the X-ray tube and the central axis p of the flat cathode 100 may be 65°. In some embodiments, the angle θ2 between the flat cathode 100 of the X-ray tube and the central axis p of the flat cathode 100 may be 75°.

In some embodiments, by setting each emission portion to form a same angle with the central axis, and setting the angle between the emission surface of the cathode sheet and the central axis of the flat cathode to be in the range of 45° to 86°, the flat cathode of the entire X-ray tube may form the spherical-like structure, so that the entire cathode assembly may form an approximately spherical Pierce cathode gun, thereby improving the uniformity of the beam spot of the electron beam and extending the service life of the X-ray tube target disk.

The Pierce electron gun may achieve better laminar beam focusing, thereby improving the uniformity of the beam spot an extending the service life of the X-ray tube target disk. However, the Pierce electron gun may generally require the cathode to be spherical or cylindrical, which is difficult to achieve for high-performance thermionic flat cathodes. In this embodiment, a focusing effect similar to that of a spherical Pierce gun may be achieved using a plurality of flat cathodes that form acute angles with a direction of beam motion.

In some embodiments, a shape of the two or more cathode sheets (the cathode sheets of the at least two emission portions) may be the same, a size of the two or more cathode sheets may be equal, and the two or more cathode sheets may be uniformly arranged in a circumferential direction along the flat cathode. The shape and the size of the two or more cathode sheets being the same, respectively may include that the shape and the size of cathode sheets of a same emission portion may be the same, respectively, or the shape and the size of cathode sheets of different emission portions may be the same, respectively, or the shape and the size of cathode sheets of all emission portions may be the same, respectively. For example, each of the four emission portions in FIG. 3 may include one cathode sheet that is shaped as a 90° sector and the four cathode sheets are equal in size. The four cathode sheets of the four emission portions may be uniformly arranged along the circumferential direction of the central axis p of the flat cathode.

In some embodiments, the cathode sheets being uniformly arranged along the circumferential direction of the flat cathode means that the cathode sheets are equally spaced along the circumferential direction of the flat cathode, or that the cathode sheets are uniformly arranged circumferentially.

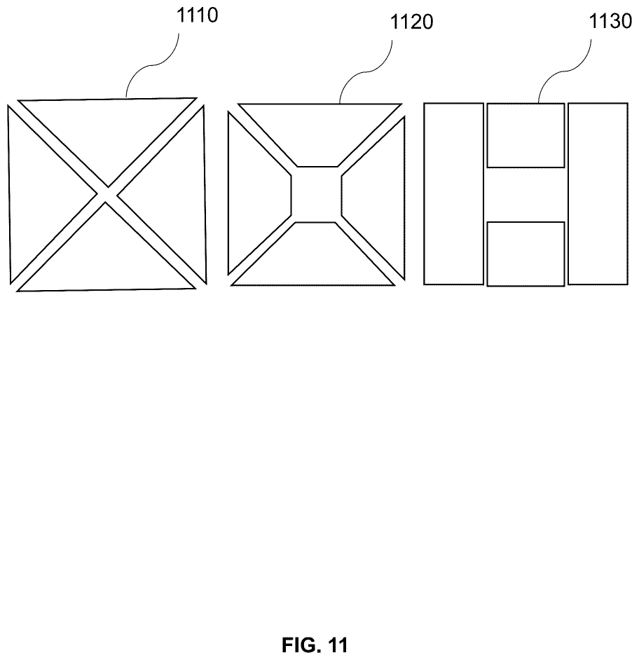

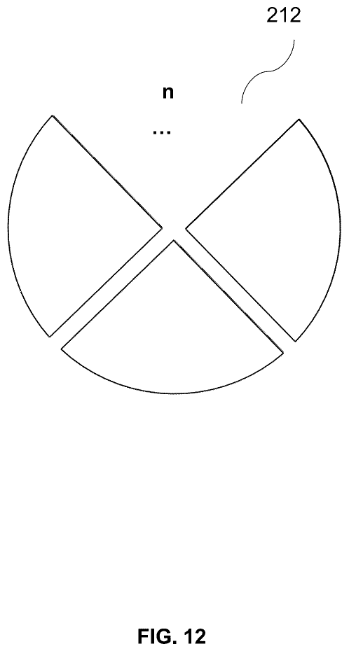

In some embodiments, the cathode sheet may be in other shapes, e.g., see FIG. 11 and the relevant descriptions thereof. A count of the cathode sheets may be other numbers, e.g., see FIG. 12 and the relevant descriptions thereof.

FIG. 11 is a schematic diagram of exemplary flat cathodes with different shapes according to other embodiments of the present disclosure.

In some embodiments, a shape of a cathode sheet of the flat cathode may be triangular, trapezoidal, rectangular, etc. in FIG. 11. It may be understood that emission portions of each flat cathode may be uniformly arranged with an equal interval around a center of the flat cathode (e.g., the arrangement of the triangular cathode sheet 1110 and trapezoidal cathode sheet 1120), or the emission portions of each flat cathode may be non-uniformly arranged with different intervals around the center of the flat cathode (e.g., the arrangement of rectangular cathode sheets 1130).

FIG. 12 is a schematic diagram of an exemplary count of flat cathodes according to other embodiments of the present disclosure.

In some embodiments, the count of emission portions (cathode sheets) of the flat cathode may be adjusted as desired. For example, the count of emission portions of the flat cathode 212 in FIG. 12 may be set to n (n is a positive integer (e.g., 2, 3, 4, 5, etc.)). The larger the count n of emission portions is, the greater the flexibility of the cathode assembly may be when the cathode assembly is adjusted for requirements of different focal point size.

In some embodiments, there may be a gap between the cathode sheets corresponding to the at least two emission portions. The gap refers to a gap between adjacent cathode sheets.

In some embodiments, the gap may include a gap between cathode sheets included within the same emission portion, or may include a gap between cathode sheets included in different emission portions (i.e., there may be a gap between any emission portions). For example, see FIG. 9, there is a first gap 2310 between any two adjacent cathode sheets, and there is a second gap 2320 between any cathode sheets arranged opposite to each other, the present disclosure can be designed in accordance with the at least two cathode sheets. In the present disclosure, when the at least two cathode sheets are used in combination, the first gap 2310 and the second gap 2320 may be configured based on a beam spot envelope distribution of the focal point. Merely by way of example, the first gap 2310 and the second gap 2320 may be set to be 0.5 mm, 0.1 mm, etc. In some embodiments, a size of the first gap 2310 may be equal to or different from a size of the second gap 2320, which is not limited herein.

The second gap 2320 may mainly affect the beam spot envelope distribution at the focal point when a plurality of cathodes are used in combination, and a specific size of the second gap may be set according to requirements.

The focusing electrode 214 may be arranged around a periphery of the flat cathode, and a first plane of the focusing electrode may form a first acute angle with a beam direction of the electron beam emitted from the flat cathode.

The focusing electrode refers to a component of an X-ray device configured to focus electrons emitted from a cathode.

In some embodiments, the focusing electrode 214 may be arranged around the periphery of the flat cathode 212. For example, the focusing electrode 214 in FIG. 8 may be arranged around the flat cathode 212 and may be centered on the geometric central axis p of the flat cathode.

In some embodiments, the first plane of the focusing electrode 214 may form the first acute angle with the beam direction of the electron beam emitted from the flat cathode 212.

The first plane refers to a plane in the focusing electrode 214 on a same side as an emission surface of the flat cathode 212. For example, the first plane of the focusing electrode 214 (i.e., the side of the focusing electrode 214 toward the flat cathode 212 (e.g., the first plane 2145)) may be set at a first acute angle 201 to the beam direction of the electron beam emitted the flat cathode 212, and the focusing electrode 214 may be configured to focus the electron beams emitted by emission portions. The first plane of the focusing electrode 214 may being set at the first acute angle, which may make the electron beams emitted by the emission portions to be Pierce-focused, thereby ensuring uniformity of the electron beam spot.

The first acute angle refers to an angle between the first plane 2145 of the focusing electrode 214 and the beam direction of the electron beam emitted from the flat cathode 212. Exemplarily, the first acute angle 201 may be as θ1 in FIG. 10. It should be noted that by adjusting the first acute angle 201, a focusing strength of the focusing electrode 214 may be adjusted, i.e., the smaller the first acute angle 201 is, the stronger the focusing strength may be. The larger the first acute angle 201 is, the weaker the focusing strength may be. In some embodiments, the first acute angle may be in a range of 45°≤θ1≤86°. For example, the first acute angle may be 45°, 50°, 60°, 70°, 80°, 75°, 65°, 86°, etc. In some embodiments, the first acute angle may be in a range of 60°≤θ1≤80°. For example, the first preset angle may be 60°, 65°, 70°, 80°, etc. Preferably, the first acute angle 201 may be equal to the second acute angle 102.

In some embodiments, a potential of the focusing electrode may be set to be the same as, or slightly lower than, a potential of the cathode to ensure that electrons do not bombard a surface of the cathode.

The cathode assembly provided in some embodiments of the present disclosure may include a plurality of cathode sheets, and each of the plurality of cathode sheets may be configured to independently emit the electron beam, so that a user may select different positions and counts of cathode sheets to emit electron beams according to actual needs, which may make the focal point size and position of the electron beam adjusted more flexibly. The size and the position of the beam spot formed by the electron beams emitted from different counts of cathode sheets and at different positions may be adjusted, thereby improving precision of electron beam treatment and an overall treatment effect. In addition, as the plurality of cathode sheets in the flat cathode of the present disclosure are all set at an acute angle to the central axis p of the flat cathode, the entire flat cathode may be similar to a Pierce structure, which may enhance the laminarity and uniformity of the electron beams and reduce a likelihood of the electron beams hitting the peripheral wall of the bulb tube during transmission, so that the wall of the bulb tube may not be easy to be damaged and the service life of the bulb tube and the entire X-ray tube may be extended.

On the other hand, in some embodiments of the present disclosure, each cathode sheet of the cathode assembly may emit the electron beam independently, which is conducive to the adjustment of the beam spot size and the focal point size, improves the adaptability of the cathode assembly under different focal point size requirements, and realizes the function of continuous adjustment from the ultra-small focal point to the ultra-large focal point. Furthermore, under the different focal point size requirements, a difference in the current passing through each emission portion may be small, which is beneficial for beam stability and the functional continuity of the cathode sheets, thereby extending the service life of the cathode sheets. The compact arrangement of the emission portions may reduce a volume of the cathode assembly, which may make a structure of the cathode assembly more compact.

In practical applications, different focal point sizes may correspond to different bulb tube powers, with a large focal point corresponding to a high power and a small focal point corresponding to a low power. If a piece of cathode needs to satisfy both high and low power requirements, a cathode temperature corresponding to the high power may be relatively high, which may affect the service life of the cathode. In some embodiments of the present disclosure, by configuring a relatively small count of emission portions when a relatively small focal point size is needed, configuring a relatively large count of emission portions when a relatively large focal point size is needed, configuring a relatively large count of cathodes when a relatively large focal point size is needed, and configuring a single or a relatively small count of cathodes when a relatively small focal point is needed, the temperature of each cathode can be effectively ensured to be relatively low, thereby improving the service life of the cathode, meeting different tube power requirements, and effectively extending the service life of the cathode sheets.

Based on the same inventive concept, some embodiments of the present disclosure also disclose a fitting hole and a cathode assembly with the fitting hole where an auxiliary electrode is arranged.

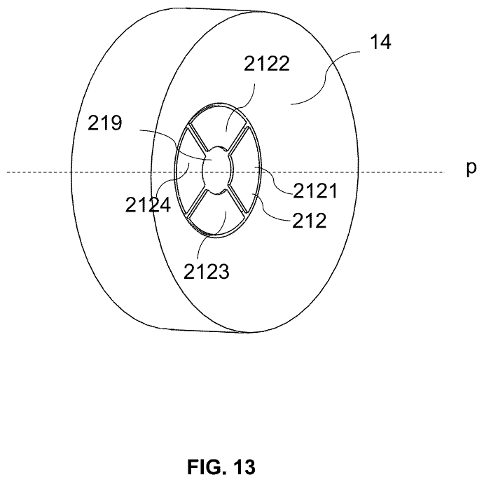

FIG. 13 is a schematic diagram of an exemplary cathode assembly including a fitting hole according to some embodiments of the present disclosure.

As shown in FIG. 13, the cathode assembly may include the flat cathode 212 and the focusing electrode 214. The flat cathode 212 may include the emission portion 2121, the emission portion 2122, the emission portion 2123, and the emission portion 2124. The emission portions may be arranged around to form a circle, and a fitting hole 219 may be formed in a center of the circle.

The fitting hole 219 may be configured to accommodate an auxiliary electrode. The auxiliary electrode may also be referred to as a grid electrode. For example, the circle may be used as the fitting hole, and the emission portions may be arranged circumferentially around the auxiliary electrode.

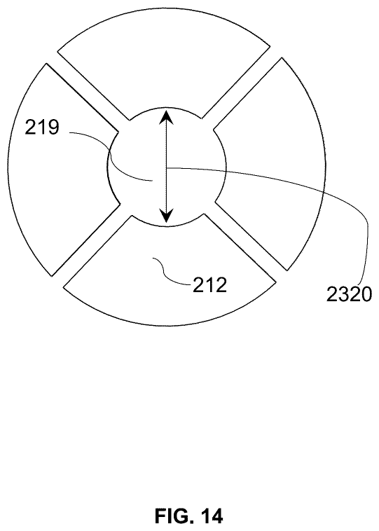

FIG. 14 is a schematic diagram of an exemplary fitting hole according to some embodiments of the present disclosure.

In some embodiments, a diameter of the fitting hole 219 may be a second gap 2320 between any oppositely disposed cathode sheets in the cathode assembly. A size of the second gap 2320 may be equal to the diameter of the fitting hole 219.

In some embodiments, the cathode assembly may further include an auxiliary electrode. The auxiliary electrode may be arranged within the fitting hole 219 surrounded by the at least two emission portions.

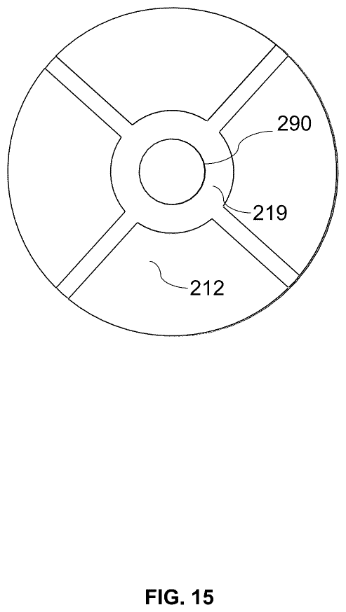

FIG. 15 is a schematic diagram of an exemplary fitting hole and an exemplary auxiliary electrode according to some embodiments of the present disclosure.

As shown in FIG. 15, the auxiliary electrodes 290 may be provided within the fitting holes 219 surrounded by the emission portions of the flat cathode 212.

In some embodiments, a center of the auxiliary electrode 290 may be the same as a center of the flat cathode.

In some embodiments, there may be a gap between the auxiliary electrode 290 and the emission portion of the flat cathode, i.e., a diameter of the fitting hole may be larger than a diameter of the auxiliary electrode.

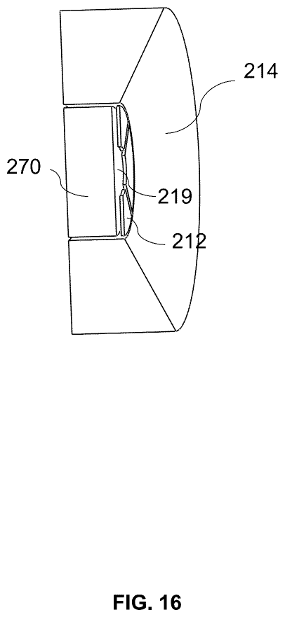

FIG. 16 is an exemplary cross-sectional view of a cathode assembly including a fitting hole according to some embodiments of the present disclosure.

As shown in FIG. 16, the emission portions of the flat cathode 212 may form the fitting hole 219 around a center of the flat cathode. The flat cathode 212 may be provided above a base 280 (in an axial direction along the center of the flat cathode), and the focusing electrode 214 may be provided around the base 280 and the flat cathode 212.

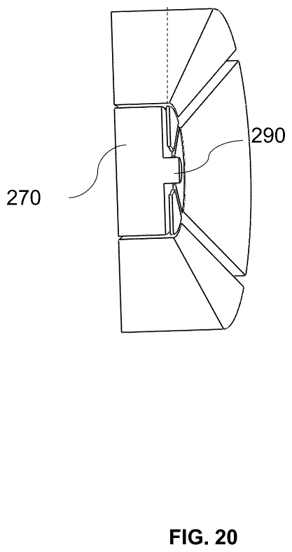

More descriptions regarding the base 280 may be found in the descriptions of FIG. 20.

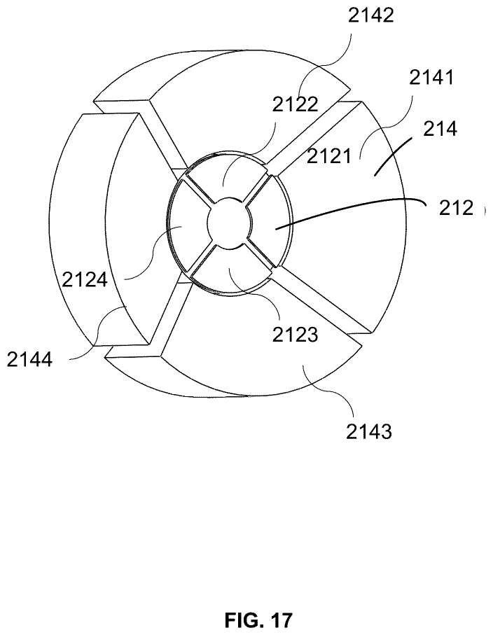

FIG. 17 is a schematic diagram of an exemplary focusing electrode of a cathode assembly according to some embodiments of the present disclosure.

In some embodiments, the focusing electrode 214 may include at least two focusing poles. The focusing poles may be obtained by dividing the focusing electrode, so the focusing poles may also be referred to as focusing sub-electrodes of the focusing electrode. In some embodiments, first planes of the at least two focusing poles may form a circular structure. The circular structure may be arranged around the flat cathode.

In some embodiments, the at least two focusing poles may be arranged in a one-to-one correspondence with the at least two emission portions of the flat cathode. For example, one focusing pole may correspond to one emission portion. Exemplarily, as shown in FIG. 17, the flat cathode 212 may include the emission portion 2121, the emission portion 2122, the emission portion 2123, and the emission portion 2124. The focusing electrode 214 may include a focusing pole 2141, a focusing pole 2142, a focusing pole 2143, and a focusing pole 2144. The emission portions may be in a one-to-one correspondence with the focusing poles in a radial direction of the flat cathode. For example, the emission portion 2121 may correspond to the focusing pole 2141, the emission portion 2122 may correspond to the focusing pole 2142, the emission portion 2123 may correspond to the focusing pole 2143, and the emission portion 2124 may correspond to the focusing pole 2144.

In some embodiments, the at least two focusing poles may be insulated from each other. Insulation may be achieved by the gap between the focusing poles or by providing an insulating layer between the focusing poles, which is not limited by this embodiment.

In some embodiments, each individual focusing pole may correspond to an individual emission portion. For example, a position and a shape of each focusing pole may be in a one-to-one correspondence with the emission portion corresponding to the focusing pole. Therefore, by adjusting a voltage of each focusing pole, the focusing of the electron beam emitted by the corresponding emission portion may be controlled, which may combine with adjusting the count of target emission portions or redetermining the target emission portions, thereby further increasing the continuity and a range for adjustment of the beam spot size and improving the adaptability of the flat cathode. At the same time, each focusing pole may be adapted to the emission portion corresponding the focusing pole, thereby making the structure of the cathode assembly more compact.

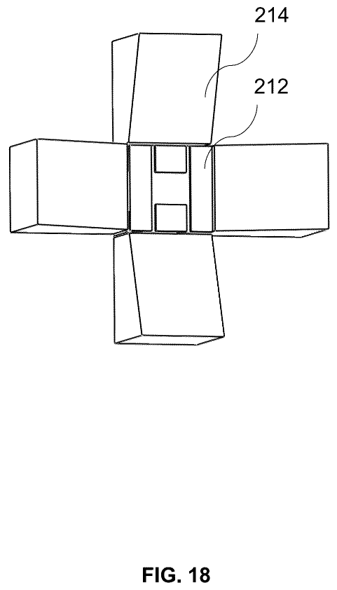

It should be noted that a shape of the focusing electrode is not limited to a circular shape. The shape of the focusing electrode may change accordingly with the shape of the flat cathode. For example, FIG. 18 is a schematic diagram of an exemplary rectangular focusing electrode according to some embodiments of the present disclosure.

It should be noted that although the cathode sheets of the flat cathode 212 in FIG. 18 are rectangular, and the shape of the focusing poles of the focusing electrode 214 is rectangular, it should be appreciated that the shape of the flat cathode being the same as, or similar to, the shape of the focusing electrode is merely provided for a preferred embodiment. In some embodiments, the flat cathode may be circular, and the focusing electrode may still be rectangular, which is not limited by this embodiment.

FIG. 19 is a schematic diagram of an exemplary cathode assembly according to some embodiments of the present disclosure.

In some embodiments, the auxiliary electrode 290 may be configured to cooperate with each focusing pole to control an electron beam emitted by an emission portion corresponding to the focusing pole.

For example, after applying an electric potential to the auxiliary electrode 290, the auxiliary electrode 290 may cooperate with each focusing pole to control the emission portion corresponding to the focusing pole, so that a degree of focusing of the electron beams emitted by each emission portion may be further controlled, thereby improving the adaptability of the cathode assembly. The real-time switching of a tube current intensity, adjustment of the size and position of the beam spot, and focus shift may be achieved by adjusting a potential difference between the auxiliary electrode 290 and the focusing pole and adjusting a potential of the auxiliary electrode, thereby further improving the adaptability of the cathode assembly.

In some embodiments, if the focusing electrode is an integrated structure, an auxiliary electrode 290 may also be provided in the fitting hole surrounded by the emission portions, and the auxiliary electrode 290 may be configured to directly cooperate with the focusing electrode 214 to control the emission portions, thereby further controlling the degree of focusing of the electron beams emitted by each emission portion and improving the adaptability of the cathode assembly.

In some embodiments, if the focusing electrode is a split structure, for example, the focusing electrode may be divided into the focusing pole 2141, the focusing pole 2142, the focusing pole 2143, and the focusing pole 2144, and the auxiliary electrode 210 may cooperate with the focusing electrode, respectively, to achieve independent control of each emission portion. For example, the auxiliary electrode 290 may cooperate with the focusing pole 2141 to realize control of the emission portion 2121, the auxiliary electrode 290 may cooperate with the focusing pole 2142 to realize control of the emission portion 2122, the auxiliary electrode 290 may cooperate with the focusing pole 2143 to realize control of the emission portion 2123, and the auxiliary electrode 290 may cooperate with the focusing pole 2144 to realize control of the emission portion 2124.

The control of the emission portion may be understood as control of the electron beam emitted by the emission portion. In other words, the auxiliary electrode may be configured to adjust an intensity of the electron beam passing through the focusing electrode. The intensity of the electron beam may be adjusted by the auxiliary electrode, which may make the intensity of the electron beam meet different usage requirements.

In some embodiments, an insulating layer may be provided between the auxiliary electrode and the at least two emission portions. For example, a gap between the auxiliary electrode and the emission portion of the flat cathode in FIG. 15 may be at least partially filled with the insulating layer.

In some embodiments, a thickness of the insulating layer may be smaller than or equal to 1 mm. The thickness of the insulating layer may be 1 mm, 0.05 mm, 0.03 mm, 0.01 mm, etc. The thickness of the insulating layer may be smaller than or equal to the gap between the auxiliary electrode and the emission portion of the flat cathode to ensure that the insulating layer is able to be set up and to ensure heat dissipation of the gap.

In some embodiments, the insulating layer may be made of a ceramic material or a ceramic composite material. For example, the insulating layer may be made of a graphene ceramic composite material, silicide ceramics, high-temperature glasses (e.g., quartz glass), etc.

In some embodiments, the insulating layer may be provided on an insulating base (not shown) and extend into the gap between the auxiliary electrode 290 and the emission portion. For example, the insulating layer may be a portion of an insulating base, and the insulating layer and the auxiliary electrode may be combined by any mechanical bonding means (e.g., gluing, threaded connection, etc.).

In this embodiment, the insulating layer may be provided between the auxiliary electrode and the at least two emission portions, which may prevent the auxiliary electrode from being pierced under a high voltage, thereby improving the overall stability of the cathode assembly.

In some embodiments, the auxiliary electrode 290 may include at least two auxiliary poles (not shown). The auxiliary pole may be understood as an auxiliary sub-pole obtained by dividing the auxiliary electrode.

The auxiliary pole may be configured to cooperate with the focusing electrode to achieve control of the electron beam emitted by the emission portion.

In some embodiments, the at least two auxiliary poles may be arranged in a one-to-one correspondence with the at least two focusing poles and/or the at least two emission portions. For example, the at least two auxiliary poles may be arranged in a one-to-one correspondence with the at least two focusing poles, and the at least two auxiliary poles may also be arranged in a one-to-one correspondence with the at least two emission portions. For example, a count of the auxiliary poles, a count of the focusing poles, and a count of the emission portions may be the same, with one auxiliary pole, one focusing pole, and one emission portion being sequentially arranged adjacent to each other outward from a geometrical center point p along a radius of the flat cathode. In terms of shape arrangement, the one auxiliary pole, the one focusing pole, and the one emission portion may form a sector structure.

In this embodiment, the auxiliary poles, the focusing poles, and the emission portions may be arranged in a one-to-one correspondence, so that a damaged component may be easy to be replaced when a portion of the structure is damaged, only the auxiliary pole and the focusing pole corresponding to the required emission portion(s) may be used when only a part of the emission portions is required to emit the electron beam, thereby improving the service life of the component, reducing energy consumption, and enhancing the precision and flexibility of control of the electron beams emitted by the emission portion. The shape of the auxiliary electrode may be adapted to the shape of each emission portion, thereby making the structure of the cathode assembly more compact to a certain extent.

FIG. 20 is an exemplary cross-sectional view of a cathode assembly including an auxiliary electrode according to some embodiments of the present disclosure.

In some embodiments, the auxiliary electrode 290 may be fixed to the base 280.

In some embodiments, the auxiliary electrode 290 may be integrally molded with the base 280 or may be fixedly connected with the base 280 in other ways, e.g., welding, riveting, etc.

Some of the embodiments described above in the present disclosure disclose a technical solution for a cathode with a split structure in which each cathode sheet (or emission portion) may be independently controlled. A single cathode sheet corresponds to an ultra-small focal point (or a low tube current), a relatively small count of cathode sheets correspond to a relatively small focal point (or a medium tube current), and a relatively large count of cathode sheets correspond to a relatively large focal point (or a high tube current). This configuration minimizes a difference in the current amplitude emitted by the cathode sheets, thereby improving the service life of the cathode sheets. Simultaneously, configuring a relatively small count of cathode sheets corresponding to a relatively small focal point, and a relatively large count of cathode sheets corresponding to a relatively large focal point minimizes the required field amplitude difference for beam control, which helps stabilize the beam. Moreover, independent control of the two or more cathode sheets ensures that a same functionality can be achieved by combining other cathode sheets in the event of a failure of one cathode sheet, thereby maintaining performance continuity.

Additionally, when combined with a Pierce focusing pole, a better laminar beam can be induced to obtain a more uniform beam spot distribution. Furthermore, through the cooperation between each of the two or more cathode sheets and the focusing electrode corresponding to the cathode sheet, independent control of the beam flow of each of the two or more cathode sheets, such as on/off control of the cathode sheet, focus shift, and modulation of the position of the cathode sheet, the beam spot envelope, etc., can be achieved. Meanwhile, the position of each cathode sheet is different, and by configuring parameters such as the gap between the cathode sheets, natural focus shift can be achieved by controlling the current emission of different cathode sheets, and multiple focal points can be simultaneously achieved on the target disk, thereby improving imaging quality.

Moreover, in addition to the combination with the Pierce focusing pole, the cathode sheet of the flat cathode 212 may be set at a second acute angle to the motion direction of the electron beam, which may make the flat cathode 212 a Pierce-like structure.

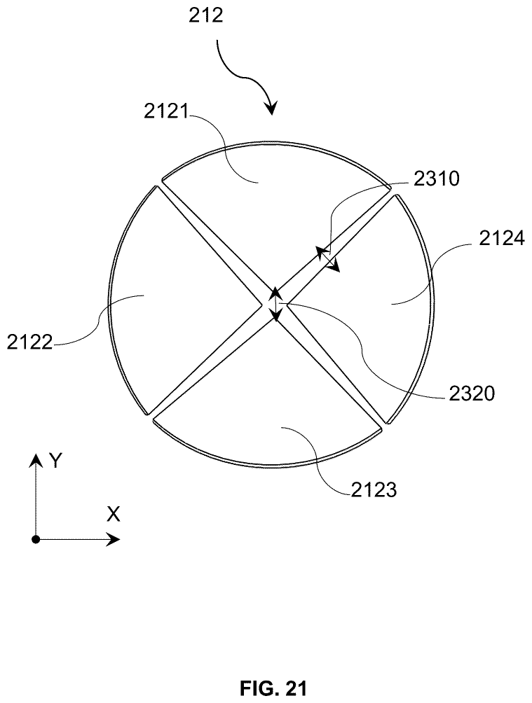

FIG. 21 is a schematic diagram of an exemplary spherical-like flat cathode according to some embodiments of the present disclosure.

To achieve a relatively good laminar flow regulation, electrical focusing may be required to ensure that the electron beam is emitted as a quasi-parallel beam. To achieve strong electrical focusing with a relatively good laminar flow of the electron beam, the cathode may be adjusted from a flat surface to a cylindrical or spherical surface. The flat cathode may not be directly made to be cylindrical or spherical, therefore, several cathodes may be spatially arranged at an angle to achieve an approximate cylindrical or spherical structure.

As shown in FIG. 21, the four emission portions of the flat cathode 212 of the cathode assembly may be arranged as a spherical-like structure according to a certain wedge angle. Specifically, the first gap 2310 between adjacent emission portions may taper from a center of the cathode assembly in a radial direction along a direction where the electron beam is emitted, and the second gap 2320 of any emission portion at the center of the cathode assembly may be the same.

Exemplarily, the emission portion 2121, the emission portion 2122, the emission portion 2123, and the emission portion 2124 may be sector-shaped, and the four emission portions may be arranged according to certain wedge angles such that the emission surface of each emission portion may form a second acute angle with the direction where the electron beam is emitted. By configuring the cathode sheet to be sector-shaped, the flat cathode 212 formed by the plurality of cathode sheets arranged circumferentially around the center of the flat cathode 212 may be the circular structure. Furthermore, the angle between the emission portion and the direction (i.e., the axis p) where the electron beam is emitted may be the second acute angle, so that the entire flat cathode 212 may form the spherical-like structure, and the entire cathode assembly may form an approximately spherical Pierce cathode gun.

In some embodiments, if the flat cathode is required to emit the electrons in a relatively good laminar beam, the second acute angle may be adjusted such that the electron beam is emitted by the cathode in a quasi-parallel beam, a slightly divergent beam, or slightly focused beam.

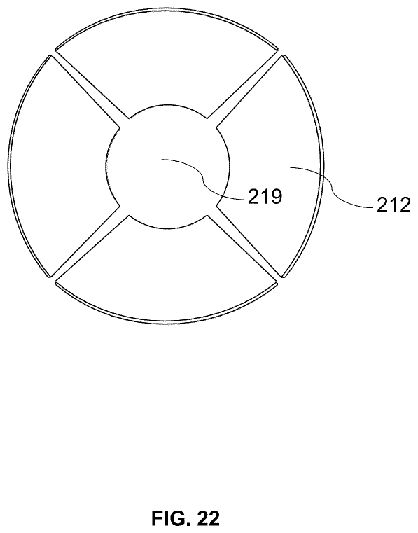

FIG. 22 is a schematic diagram of an exemplary spherical-like flat cathode according to other embodiments of the present disclosure. Compared to FIG. 21, the fitting hole 219 may be added in the center of the flat cathode 212 in FIG. 22. Similarly, the emission portions of the flat cathode may be arranged at a certain wedge angle, so that the entire flat cathode may form a spherical-like structure. The fitting hole 219 may be configured to accommodate an auxiliary electrode.

FIG. 23 is a schematic diagram of an exemplary cathode assembly including a spherical-like flat cathode according to some embodiments of the present disclosure.

In FIG. 23, the flat cathode 212 may be provided as a spherical-like structure, a plurality of emission portions may form the fitting hole 219 around a direction where the electron beam is emitted, and the focusing electrode 214 may be provided around the flat cathode 212.

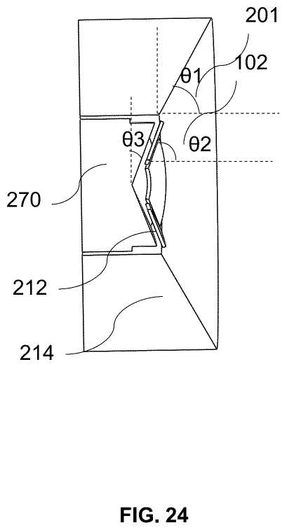

FIG. 24 is an exemplary cross-sectional view of the cathode assembly of FIG. 23 of the present disclosure.

FIG. 24 shows a second acute angle 102 between the emission portion of the flat cathode 212 and the direction where the electron beam is emitted, and a first acute angle 201 between the focusing electrode 214 and the beam direction of the electron beam (a line parallel to the beam direction in the figure).

In some embodiments, the base 280 may be configured to include a wedge-shaped structure as shown in FIG. 24. For example, a surface of the base facing the emission portions may be configured to form a wedge angle θ3 with a radial direction perpendicular to the direction where the electron beam is emitted. A value of wedge angle θ3 may be set according to needs, e.g., 30°, 45°, etc.

In some embodiments, the first acute angle 201 and the second acute angle 102 may be equal in size. For example, both the first acute angle 201 and the second acute angle 102 may be configured to be in a range of 45° to 86°.

In some embodiments, the wedge angle θ3 may be complementary to the second acute angle 102 or the first acute angle 201, i.e., a sum of the wedge angle θ3 and the second acute angle, or a sum of the wedge angle θ3 and the first acute angle is 90°.

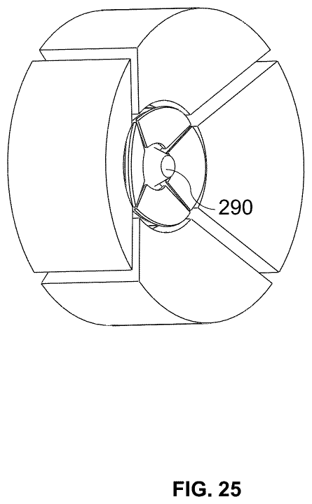

FIG. 25 is a schematic diagram of an exemplary cathode assembly including an auxiliary electrode according to other embodiments of the present disclosure.

In some embodiments, the auxiliary electrode may be configured not to obstruct a movement of electron beams in a beam direction. The movement of the electron beam may not be obstructed in the beam direction, which may make the electron beam not bombard a surface of the auxiliary electrode.

In some embodiments, since the motion direction of the electron beam may not be a direction parallel to the central axis of the flat cathode in the case where the focusing electrode and the auxiliary electrode control the electron beam emitted by the emission portion, to prevent the electrons from bombarding onto the surface of the auxiliary electrode, the structure of the auxiliary electrode may be made to gradually decrease in size along the beam motion direction. For example, a radial size of the auxiliary electrode may be configured to taper along the direction where the electron beam is emitted.

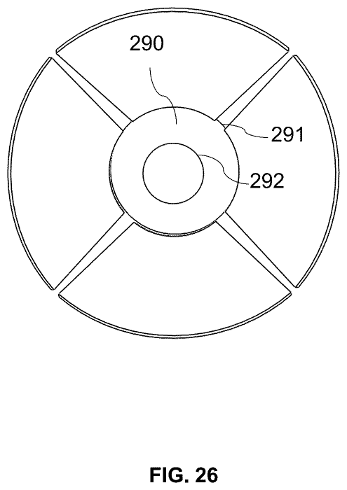

FIG. 26 is a schematic diagram of an exemplary flat cathode and an exemplary auxiliary electrode according to some embodiments of the present disclosure.

As shown in FIG. 26, a size of the auxiliary electrode 290 may vary from large to small along a direction (perpendicular to the paper direction in FIG. 26) where the electron beam is emitted. A radial size 291 represents a largest size of the auxiliary electrode, and a radial size 292 represents a smallest size of the auxiliary electrode.

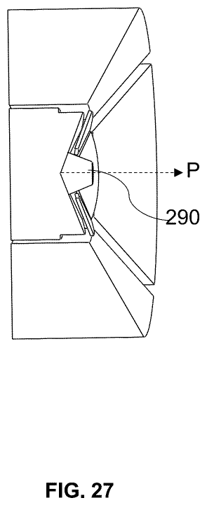

FIG. 27 is an exemplary cross-sectional view of a cathode assembly and an auxiliary electrode according to some embodiments of the present disclosure.

In the cathode assembly as shown in FIG. 27, the radial size of the auxiliary electrode 290 may gradually decrease in the direction (direction p) where the electron beam emits electrons, i.e., the radial size of the auxiliary electrode 290 may gradually decrease along the direction of the arrow. For example, a radial size of an end of the auxiliary electrode 290 away from the base may be smaller than a radial size of an end of the auxiliary electrode close to the base. The decrease in the radial size may be linear or non-linear.

In this embodiment, by changing the radial size of the auxiliary electrode, the possibility of the electron beam emitted by the emission portion hitting the auxiliary electrode may be reduced, thereby improving the reliability of the cathode assembly.

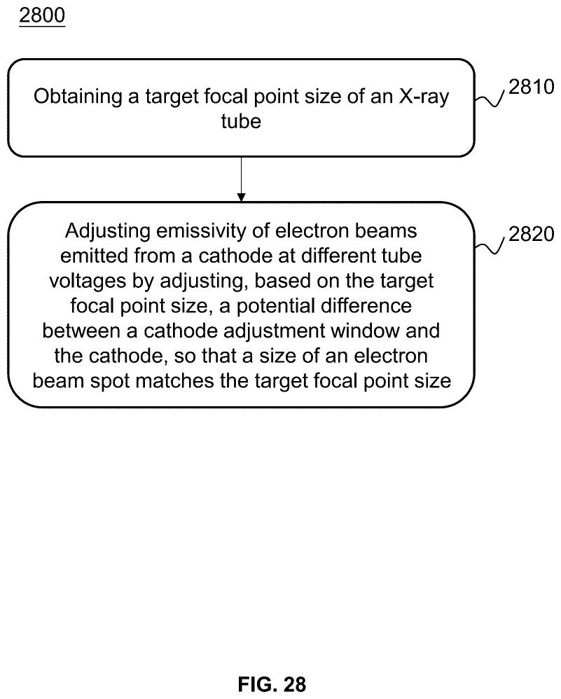

FIG. 28 is a flowchart of an exemplary process for adjusting a focal point of an X-ray tube according to some embodiments of the present disclosure. In some embodiments, the process 2800 may be performed by a system 3600 for adjusting a focal point of an X-ray tube or a processing device (e.g., the processing device 120). As shown in FIG. 28, the process 2800 may include the following operations.

In 2810, a target focal point size of the X-ray tube may be obtained. In some embodiments, the operation 2810 may be performed by an obtaining module 3610.

The focal point size refers to a size of a focal point formed by an electron beam emitted by a cathode assembly on an anode surface, i.e., a size of an electron beam spot. Different radiation powers or scanning parameters may require different focal point sizes. The radiation power and/or scanning parameter may be set by a user or defaulted by the system. The target focal point size refers to a focal point size determined according to a current radiation power and/or current scanning parameters. In some embodiments, the focal point may be circular, square, or in other shapes, and the focal point size may be defined by a diameter, radius, length, width, etc. For example, a diameter of the focal point size may be in a range of 0.1 mm-3 mm. As another example, an edge length of the focal point size may be in a range of 0.1 mm-3 mm. Merely by way of example, the focal point size may be represented by 2 mm*2 mm or 1.5 mm*1.5 mm.

In some embodiments, the obtaining module 2810 (or the processing device 120) may obtain the radiation power and/or scanning parameters set by the user and determine the target focal point size of the X-ray tube according to the radiation power and/or scanning parameters set by the user. In some embodiments, the obtaining module 2810 may obtain a radiotherapy plan of the user. The radiotherapy plan may include the radiation power, and the obtaining module 2810 may determine the target focal point size of the X-ray tube according to the radiotherapy plan.

In 2820, emittance of the electron beams emitted from the cathode at different tube voltages may be adjusted by adjusting, based on the target focal point size, a potential difference between the cathode adjustment window and the cathode, so that a size of the electron beam spot may match the target focal point size. In some embodiments, the operation 2820 may be performed by an adjustment module 3620.

The emittance of the electron beam emitted from the cathode refers to a parameter that measures quality of the electron beam. The emittance of the electron beam emitted from the cathode may be related to a cathode emission area and a divergence angle of the electron beam emitted from the cathode. The emittance of the electron beam emitted from the cathode may be equal to a product of the divergence angle of the electron beam emitted from the cathode and the cathode emission area. A focal point size formed at the anode of the X-ray tube may be related to the emittance of the electron beam emitted from the cathode. That is, the focal point size formed at the anode of the X-ray tube may be related to the divergence angle of the electron beam emitted from the cathode and the cathode emission area. The potential difference between the cathode adjustment window and the cathode may be configured to adjust the cathode emission area by adjusting a magnitude of a tube current of the X-ray tube, and may also be configured to adjust the divergence angle of the electron beam emitted from the cathode.

For example, FIG. 29 shows a relationship between a tube current of an X-ray tube and a potential difference between the potential V3 of the cathode adjustment window 216 and the potential V1 of the cathode 212. The abscissa is ΔV=V3−V1. If V3 is smaller than V1, ΔV is negative. As can be seen from FIG. 29, the larger the ΔV is, the larger the tube current emitted from the cathode is. There is a one-to-one correspondence between the emitted tube current and the potential difference.

FIG. 30 shows a relationship between a cathode emission area and a potential difference between the potential V3 of the cathode adjustment window 216 and the potential V1 of the cathode 212. The three potential differences 601, 602, and 603 in FIG. 29 correspond to the cathode emission areas S1, S2, and S3, respectively. It can be seen that there is also a one-to-one correspondence between the cathode emission area and the potential difference between the cathode adjustment window 216 and the cathode 212, and the larger the potential difference is, the larger the cathode emission area corresponding to the potential difference is. Therefore, the cathode emission area may be adjusted by adjusting the potential difference between the cathode adjustment window and the cathode, and the focal point size may be adjusted by adjusting the cathode emission area. When the divergence angle of the electron beam emitted from the cathode of the X-ray tube is constant, the larger the cathode emission area is, and the larger the emittance of the electron beam emitted from the cathode is, the larger the focal point size that can be achieved may be. The smaller the cathode emission area is, the larger the cathode emission is. The smaller the cathode emission area is, and the smaller the emittance of the electron beam emitted from the cathode is, the smaller the focal point size that can be achieved may be.

A relationship between the tube current and the potential difference between the cathode adjustment window and the cathode may be related to a cathode temperature. The higher the cathode temperature is, and the greater the maximum tube current that can be emitted from the cathode is, the greater the potential difference corresponding to the maximum tube current that can be emitted from the cathode may be. A relatively high cathode temperature may make the relationship between the tube current and the potential difference at a relatively low cathode temperature fixed. That is, when the cathode temperature rises to a certain degree, the tube current cannot be increased, and the relationship between the tube current and the potential difference is fixed accordingly. The cathode temperature may be related to a current passing through the cathode. The higher the current passing through the cathode is, the higher the cathode temperature may be. The lower the current passing through the cathode is, the smaller the cathode temperature may be.

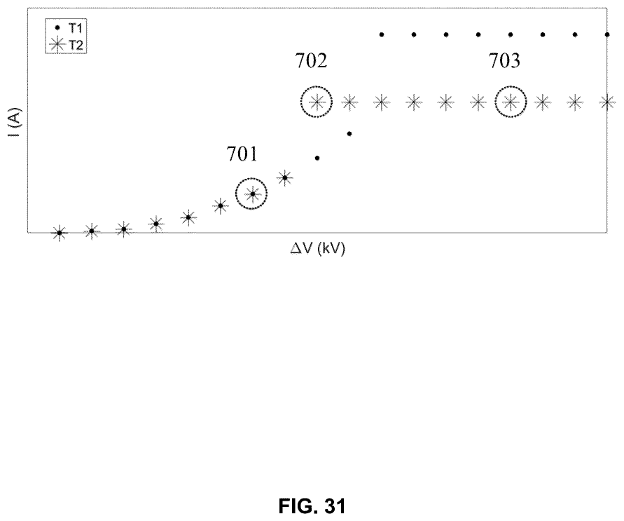

Merely by way of example, FIG. 31 is a schematic diagram of relationships, at different cathode temperatures, between a tube current and a potential difference between a cathode adjustment window and a cathode. The abscissa is the potential difference between the cathode adjustment window and the cathode. The ordinate is the tube current. The relationship between the tube current and the potential difference between the adjustment window and the cathode is related to the cathode temperature. As can be seen from FIG. 31, the maximum tube current that can be emitted from the cathode when the temperature is T1 is greater than the maximum tube current that can be emitted from the cathode when the temperature is T2, and the cathode temperature T1 is higher than the cathode temperature T2. In other words, the higher the cathode temperature is, the greater the maximum tube current that can be emitted from the cathode may be. In addition, the potential difference corresponding to the maximum tube current when the cathode temperature is T1 is greater than the potential difference corresponding to the maximum tube current when the cathode temperature is T2. In other words, the higher the cathode temperature is, the greater the potential difference corresponding to the maximum tube current that can be emitted from the cathode may be. Furthermore, as can also be seen from FIG. 31, a relatively high cathode temperature may make the relationship between the tube current and the potential difference at a relatively low cathode temperature fixed. That is, when the cathode temperature rises to a certain degree, the tube current cannot be increased, and the relationship between the tube current and the potential difference is fixed accordingly. At the point 701 in FIG. 31, the abscissas of the relationships corresponding to the cathode temperatures T1 and T2 are the same, the ordinates of the relationships corresponding to the cathode temperatures T1 and T2 are the same, and no matter how much the cathode temperature is increased, the tube current may not be changed any more. Since the cathode emission area is related to a magnitude of the tube current, the cathode emission area may not be changed when the cathode temperature is increased at this time, and the cathode emission area is smaller than an initial cathode emission area. At the points 702 and 703 in FIG. 31, when the potential difference is adjusted to reach the maximum tube current, even if the cathode emission area may not be changed, the potential difference may be further increased to adjust the divergence angle of the electron beam. The greater the potential difference between the cathode adjustment window and the cathode is, the smaller the divergence angle of the electron beam corresponding to the potential difference is. In summary, it can be seen that since the relationship between the tube current and the potential difference between the cathode adjustment window and the cathode may be different at different tube voltages, the focal point adjustment may be achieved by adjusting, by adjusting the potential difference, the divergence angle of the electron beam or the cathode emission area, respectively.

In some embodiments, the obtaining module 3610 may obtain an operating tube voltage. The operating tube voltage refers to a tube voltage when the cathode emits the electron beam in an operating state. For a dual-energy scanning device, the X-ray tube may perform scanning tasks at two different operating tube voltages. However, due to a difference in the operating tube voltages, the relationship between the tube current and the potential difference between the cathode adjustment window and the cathode may also be different. Therefore, a manner for adjusting the focal point may need to be determined according to the current tube voltage. The operating tube voltage may include a first tube voltage and a second tube voltage. The first tube voltage may be an operating tube voltage that is smaller than a first tube voltage threshold, which may be understood as a low-voltage tube voltage (e.g., 70 kV˜100 kV). The second tube voltage may be an operating tube voltage that is greater than a second tube voltage threshold, which may be understood as a high-voltage tube voltage (e.g., 130 kV˜150 kV). In some embodiments, the first tube voltage threshold and the second tube voltage threshold refer to voltage thresholds for determining the operating tube voltage. The first tube voltage threshold may be smaller than or equal to the second tube voltage threshold. For example, both the first tube voltage threshold and the second tube voltage threshold may be 120 kV. As another example, the second tube voltage threshold may be 120 kV and the first tube voltage threshold may be 110 kV. When the tube voltage of the dual-energy device are switched, a size requirement of the focal point may not change, so different focal points may not be adjusted generally during dual-energy switching.

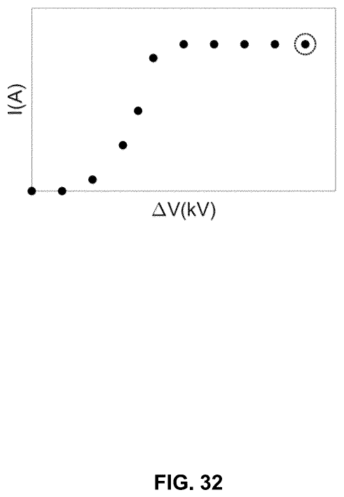

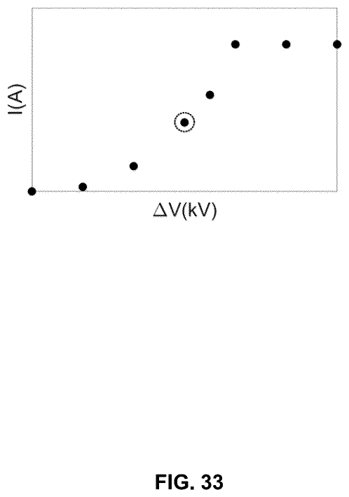

FIG. 32 is a schematic diagram of a relationship between a potential difference and a tube current at a low-voltage tube voltage (e.g., 70 kV). FIG. 33 is a schematic diagram of a relationship between a potential difference and a tube current at a high-voltage tube voltage (e.g., 140 kV). In conjunction with FIG. 31, it can be seen that to satisfy an operating mode of adjusting a divergence angle at the low-voltage tube voltage, different focal point sizes may need to correspond to a cathode temperature to change the relationship between the potential difference and the tube current. For the low-voltage tube voltage, the potential difference may be adjusted by adjusting the corresponding cathode temperature, so that the divergence angle of the emitted electron beam may be close to or equal to zero. In this way, the emitted electron beam may not hit a tube wall of the X-ray tube. For the high-voltage tube voltage, the cathode emission area may be changed by adjusting the potential difference, and the emittance of the electron beam may be adjusted, so that a size of an electron beam spot may match a desired focal point size.

In some embodiments, the obtaining module 3610 may obtain a radiation power corresponding to the target focal point size. The radiation power may be set by a user. In some embodiments, the radiation power may be included in a radiotherapy plan corresponding to the target focal point size. More descriptions regarding the radiation power may be found in the operation 3610. Merely by way of example, the user may set the operating tube voltage to be 70 kV, the radiation power to be 40 kW, and a diameter of the target focal point size to be 2 mm.

In some embodiments, the adjustment module 3620 may determine a target tube current A at the operating tube voltage based on the target focal point size and the corresponding radiation power. Each focal point size may correspond to a unique target tube current at a given operating tube voltage. If the X-ray tube operates at a single operating tube voltage (i.e., the operating tube voltage is unique), the target tube current A may be the tube current at the operating tube voltage. If the X-ray tube operates at a plurality of tube voltages, for example, the X-ray tube is applied in a multi-energy device (e.g., a dual-energy device), that is, the operating tube voltage includes at least a first tube voltage and a second tube voltage, the target tube current A may be a maximum tube current at the operating tube voltage. In the case of the first tube voltage, the target tube current A may be the maximum tube current at the first tube voltage, and the first tube voltage may be a tube voltage with a relatively small voltage value. In the case of the second tube voltage, the target tube current A may be a corresponding tube current at the second tube voltage, and the second tube voltage may be a tube voltage with a relatively large voltage value.

In some embodiments, the adjustment module 3620 may determine the target tube current A corresponding to the target focal point size at the operating tube voltage according to a relationship between the target focal point size, the radiation power, and the target tube current. The relationship between the target focal point size, the radiation power, and the target tube current at the operating tube voltage may be represented by a function or a lookup table. Furthermore, the adjustment module 3620 may adjust the cathode temperature to make the cathode emit the target tube current A. In some embodiments, the adjustment module 3620 may adjust, by adjusting a current passing through the cathode based on the target tube current A, the cathode temperature to make the cathode emit the target tube current A. For example, an appropriate cathode temperature may be determined using the function or the lookup table, so that the cathode may emit the target tube current A. In some embodiments, the adjustment module 3620 may adjust the current passing through the cathode based on a relationship between the cathode temperature, the potential difference between the cathode adjustment window and the cathode, and the tube current. For example, the appropriate cathode temperature may be determined according to a schematic diagram of a relationship similar to FIG. 31, so that the cathode may emit the target tube current A. In some embodiments, the adjustment module 3620 may adjust the cathode temperature by adjusting the current passing through the cathode. The cathode may be a resistor, and the cathode temperature may increase when the current passes through. The temperature of the cathode may determine a count of electrons that are emitted. The higher the temperature is, the more the electrons may be released, and the higher the current may be.

In some embodiments, in response to determining that the current operating tube voltage is smaller than a first tube voltage threshold, for example, if the current operating tube voltage is the first tube voltage, the adjustment module 3620 may adjust, based on the potential difference, a divergence angle of the electron beam emitted from cathode. In response to determining that the current operating tube voltage is greater than a second tube voltage threshold, for example, if the current operating tube voltage is the second tube voltage, the adjustment module 3620 may adjust, based on the potential difference, a cathode emission area of the electron beam emitted from the cathode. The current operating tube voltage refers to an operating tube voltage obtained in real time. For a single operating tube voltage, the current operating tube voltage may be a fixed tube voltage value. For a plurality of operating tube voltages, for example, the X-ray tube is applied in a dual-energy device, the current operating tube voltage may be the first tube voltage or the second tube voltage.

In some embodiments, when the X-ray tube is disposed in the dual-energy device, the adjustment module 3620 may determine a first potential difference between the cathode adjustment window and the cathode at the first tube voltage based on the target focal point size, the radiation power, and the first tube voltage. Specifically, the adjustment module 3620 may determine the first potential difference based on the target tube current and the divergence angle. The target tube current refers to a target tube current at the operating tube voltage determined according to the target focal point size and the radiation power. Due to the dual-energy device, the target tube current may be the maximum tube current under the operating tube voltage. In the case of the first tube voltage, the target tube current may be the maximum tube current at the first tube voltage, and the first tube voltage may be the tube voltage with a relatively small voltage value. In some embodiments, the adjustment module 3620 may also determine a second potential difference between the cathode adjustment window and the cathode at the second tube voltage based on the target focal point size, the radiation power, and the second tube voltage. Specifically, the adjustment module 3620 may obtain a first relationship between a magnitude of the tube current and the potential difference, and determine the second potential difference based on the target tube current and the first relationship. In the case of the dual-energy device and the second tube voltage, the target tube current may be the corresponding tube current at the second tube voltage, and the second tube voltage may be the tube voltage with a relatively large voltage value. The adjustment module 3620 may further adjust the cathode adjustment window based on the first potential difference and the second potential difference. The first tube voltage may be smaller than the first tube voltage threshold, the second tube voltage may be greater than the second tube voltage threshold, and the first tube voltage threshold may be smaller than or equal to the second tube voltage threshold. The first potential difference may be configured to adjust the divergence angle of the electron beam emitted from the cathode, and the second potential difference may be configured to adjust a cathode emission area of the electron beam emitted from the cathode.

The operating tube voltage of the dual-energy device may generally include a fixed first tube voltage (e.g., 70 kV) and a fixed second tube voltage (e.g., 140 kV). For a given target focal point size, the adjustment module 3620 may predetermine the first potential difference between the cathode adjustment window and the cathode at the first tube voltage and a second potential difference between the cathode adjustment window and the cathode at the second tube voltage. In the process of switching between the first tube voltage and the second tube voltage, if the current operating tube voltage is the first tube voltage, the adjustment module 3620 may adjust the cathode adjustment window based on the first potential difference; if the current operating tube voltage is switch to the second tube voltage, the adjustment module 3620 may adjust the cathode adjustment window based on the second potential difference. For example, the adjustment module 3620 may adjust a potential of the cathode adjustment window, so that the potential difference between the cathode adjustment window and the cathode may be the first potential difference or the second potential difference. At this time, the size of the electron beam spot may be the target focus size.

In some embodiments, the processor may also gradually make the size of the electron beam spot of the electron beam emitted by the cathode be the first focal point size by adjusting the potential difference between the cathode adjustment window and the cathode one or more times.

In some embodiments, if the current operating tube voltage is smaller than the first tube voltage threshold (e.g., the current operating tube voltage is the first tube voltage), the adjustment module 3620 may determine the first potential difference based on the target tube current A and the divergence angle, and adjust the cathode adjustment window based on the first potential difference. The target tube current A at the operating tube voltage may be determined by the target focal point size and the corresponding radiation power. For a single operating tube voltage and when the operating tube voltage is the first tube voltage (low-voltage tube voltage), the target tube current A may be the maximum tube current corresponding to the target focal point size at the first tube voltage. The adjustment module 3620 may determine, based on the target tube current A, the potential difference when the divergence angle tends to zero as the first potential difference. In the case of the low-voltage tube voltage, a magnitude of the tube current may be the target tube current A that the cathode emits (i.e., the maximum tube current at the low-voltage tube voltage). At this time, since the tube current no longer increases with the increase of the potential difference, and the cathode emission area is fixed (for example, cathode emission area is fixed as the initial emission area (i.e., all cathode emission area emits electron beams)), only the divergence degree of the electron beam emitted from the cathode may be adjusted by adjusting the potential difference. The adjustment module 3620 may obtain a relationship between the divergence degree of the electron beam and the potential difference, and determine, according to the relationship between the divergence degree of the electron beam and the potential difference, the potential difference when the divergence angle tends to be close to or equal to zero as the first potential difference.

In some embodiments, the adjustment module 3620 may adjust the potential (e.g., the potential V3) of the cathode adjustment window (e.g., a cathode adjustment window 316) based on the first potential difference to make the divergence angle of the electron beam tend to be close to or equal to zero, thereby adjusting the emittance of the electron beam emitted from the cathode, so that the size of the electron beam spot may match the target focal point size. Since the target tube current at the operating tube voltage is determined and the cathode temperature is adjusted in advance according to the target focal point size, at this time, the tube current of the X-ray tube may be the target tube current, and the target tube current may correspond to the target focal point size, that is, the focal point size when the emittance of the electron beam is close to or is equal to zero may be the target focal point size.

In some embodiments, if the current operating tube voltage is greater than the second tube voltage threshold (e.g., the current operating tube voltage is the second tube voltage), the adjustment module 3620 may obtain the first relationship between the magnitude of the tube current and the potential difference, determine the second potential difference based on the target tube current and the first relationship, and adjust the cathode adjustment window based on the second potential difference. There may be a one-to-one correspondence (i.e., the first relationship) between the magnitude of the tube current size and the potential difference. There may be a one-to-one correspondence (i.e., the second relationship) between the magnitude of the tube current and the cathode emission area. The magnitude of the tube current may be changed by adjusting the potential difference between the cathode adjustment window and the cathode, thereby adjusting the cathode emission area. The change in the cathode emission area may result in a change in the emittance of the emitted electron beam, thereby changing the size of the electron beam spot. Therefore, the target tube current may be determined based on the target focal point size, the radiation power, and the operating tube voltage, the second potential difference may be determined based on the target tube current, and the cathode adjustment window may be adjusted based on the second potential difference to achieve the purpose of adjusting the cathode emission area, and finally make the size of the electron beam spot match the target focal point size. For a single operating tube voltage and when the operating tube voltage is the second tube voltage (i.e., high-voltage tube voltage), the target tube current A may be the tube current corresponding to the target focal point size at the second tube voltage.

In some embodiments, the adjustment module 3620 may obtain the first relationship between the magnitude of the tube current and the potential difference. For example, as shown in FIG. 29, points 601, 602, and 603 of different tube currents have potential differences corresponding to different tube currents, respectively. Therefore, the adjustment module 3620 may determine or simulate the first relationship in advance and store the first relationship in a storage module. The first relationship may be accessed at any time by the adjustment module 3620. The first relationship may be represented by a function or may be represented by a lookup table.

In some embodiments, the adjustment module 3620 may determine the second potential difference based on the target tube current and the first relationship. For example, when the first relationship is a function, the adjustment module 3620 may input the target tube current into the function to directly output the second potential difference; when the first relationship is a lookup table, the adjustment module 3620 may directly look up the second potential difference corresponding to the target tube current in the lookup table.

In some embodiments, there may be the second relationship between the magnitude of the tube current and the cathode emission area. The second relationship indicates a positive correlation between the magnitude of the tube current and the cathode emission area. For example, as shown in FIGS. 29 and 30, points 601, 602, and 603 of different tube currents have cathode emission areas S1, S2, and S3 corresponding to different tube currents, respectively. Therefore, the adjustment module 3620 may determine or simulate the second relationship in advance and store the second relationship in the storage module. The second relationship may be accessed at any time by the adjustment module 3620. The second relationship may be represented by a function or may be represented by a lookup table.

In some embodiments, the adjustment module 3620 may adjust the potential (e.g., the potential V3) of the cathode adjustment window (e.g., the cathode adjustment window 216) based on the second potential difference, thereby adjusting the cathode emission area, so that the size of the electron beam spot may match the target focal point size.

In some embodiments of the present disclosure, the divergence angle of the electron beam emitted from the cathode or the cathode emission area may be adjusted by adjusting the potential difference at different tube voltages, so that the focal point size may be adjusted in a large range and a focal point of any size may be obtained. The cathode may be shaped as the approximately spherical Pierce cathode. The cathode emission area in all directions in the plane may decrease with the decrease of the potential difference, and a peripheral region of the cathode emission area may have a large radius with a high proportion of the area decrease. Therefore, compared to the rectangular cathode, the cathode emission area may decrease more with the same reduction in size, and the focal point size may also be reduced more in the case of a small constant focusing ratio, so that a relatively small focal point size may be obtained. Meanwhile, without the adjustment of the cathode emission area, since the cathode assembly is the Pierce structure, which may lead to a significant increase in the emittance of the electrons and a severe electron divergence. On the one hand, the focusing may be achieved by a focusing element. On the other hand, the size of the beam pipe may need to be increased, and increasing the size of the beam pipe may make the X-ray tube structure no longer compact. The focal point size may be adjusted by the focusing element when a relatively large focal point size needs to be obtained, and the pressure of the focusing element may not be large. However, when a relatively small focal point size needs to be obtained, a focusing force of a magnetic focusing element may need to be increased greatly, that is, a current of the focusing element may need to be increased greatly, and the burden of the focusing element may be large. At the same time, when a first quadrupole magnet focuses the electrons in one direction, the electrons in another direction perpendicular to the direction may diverge, which may make the electron beam that is already heavily divergent continue to diverge, and the beam pipe may be further enlarged. As a result, it is often difficult to obtain a relatively smaller focal point, thereby leaving the spatial resolution limited. However, in the embodiments of the present disclosure, the cathode emission area may be adjusted substantially. Without increasing the current of the magnetic focusing element and the size of the beam pipe, a specific focal point size within a relatively large range may be obtained, for example, an ultra-small focal point size (e.g., 0.1 mm order of magnitude) and to an ultra-large focal point size (e.g., 3 mm order of magnitude) may be obtained. The ultra-large focal point and high dosage may achieve a relatively high temporal resolution to cope with the fast scanning of dynamic organs (e.g., heart, lung, etc.). The ultra-small focal point and low dosage may improve spatial resolution to cope with clear scanning of static organs (e.g., blood vessels, etc.).

It should be noted that the descriptions of the process 2800 are merely provided for example and illustration, and not intended to limit the scope of application of the present disclosure. For those skilled in the art, various modifications and variations may be made to the process 2800 under the guidance of the present disclosure. However, these modifications and variations remain within the scope of the present disclosure.

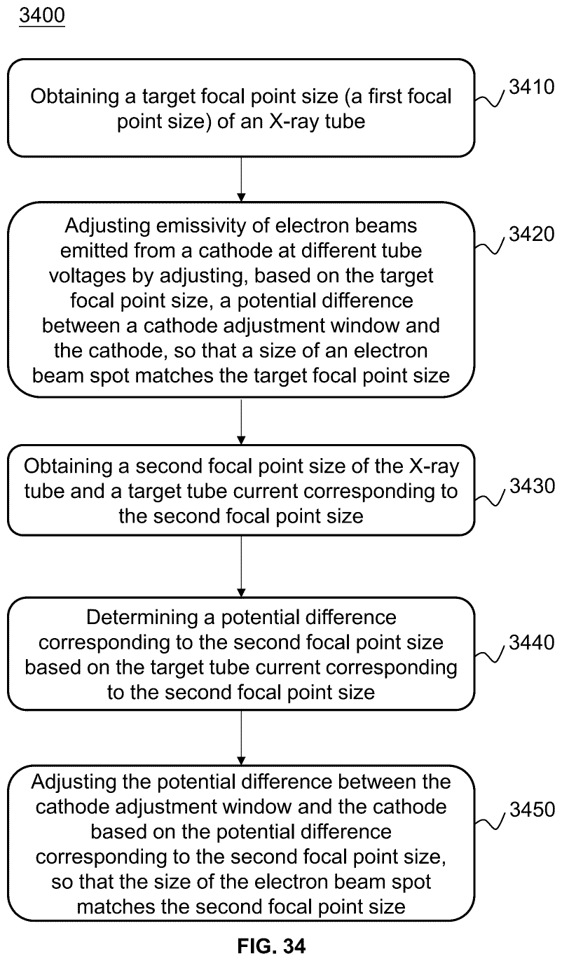

FIG. 34 is a flowchart of an exemplary process for adjusting a focal point of an X-ray tube according to some embodiments of the present disclosure. In some embodiments, the process 3400 may be performed by the system 3600 for adjusting a focal point of an X-ray tube or a processing device (e.g., the processing device 120). As shown in FIG. 34, the process 3400 may include the following operations.

In 3410, a target focal point size (which may also be referred to as a first focal point size) of the X-ray tube may be obtained. In some embodiments, the operation 3410 may be performed by the obtaining module 3610.

In 3420, emittance of electron beams emitted from a cathode at different tube voltages may be adjusted by adjusting, based on the target focal point size, a potential difference between the cathode adjustment window and the cathode, so that a size of an electron beam spot may match the target focal point size. In some embodiments, the operation 3420 may be performed by the adjustment module 3620.

In 3430, a second focal point size of the X-ray tube and a target tube current corresponding to the second focal point size may be obtained. In some embodiments, the operation 3430 may be performed by the obtaining module 3610.

The second focal point size refers to a focal point size determined according to a second radiation power and/or second scanning parameters. In some embodiments, the target focal point size may be considered as a focal point size before adjustment, and the second focal point size may be considered as a focal point size after adjustment. The second focal point size may be smaller than the target focal point size.

In some embodiments, a ratio between the target focal point size and the second focal point size may be greater than 2. For example, a diameter of the target focal point size may be 2.5 mm, and a diameter of the second focal point size may be 0.5 mm. As another example, the diameter of the target focal point size may be 1.5 mm, and the diameter of the second focal point size may be 0.3 mm. As can be seen by the ratio between the target focal point size and the second focal point size, when the focal point size is adjusted from the target focal point size to the second focal point size, the focal point size may be adjusted within a large range in the embodiments of the present disclosure.

In some embodiments, the ratio between the target focal point size and the second focal point size may be greater than 3.

In some embodiments, the ratio between the target focal point size and the second focal point size may be greater than 4.

In some embodiments, the ratio between the target focal point size and the second focal point size may be greater than 5.

More descriptions regarding the second focal point size and the manner for obtaining the second focal point size are similar to that of the target focal point size, which will not be repeated herein.

When an operating tube voltage is greater than the second tube voltage threshold, a target tube current corresponding to the second focal point size may be a target tube current B corresponding to the second focal point size at a given operating tube voltage. In some embodiments, the target tube current B corresponding to the second focal point size may be determined according to the second focal point size and a radiation power corresponding to the second focal point size. For a single operating tube voltage and when the operating tube voltage is the second tube voltage, the target tube current B may be a tube current corresponding to the target focal point size at the second tube voltage. The target tube current B corresponding to the second focal point size may be determined in a manner similar to the manner in which the target tube current A corresponding to the target focal point size at the operating tube voltage is determined, which will not be repeated herein.

In 3440, a potential difference corresponding to the second focal point size may be determined based on the target tube current corresponding to the second focal point size.

In 3450, a potential difference between the cathode adjustment window and the cathode may be adjusted based on the potential difference corresponding to the second focal point size, so that the size of the electron beam spot may match the second focal point size. At this time, the current operating tube voltage may be greater than the second tube voltage threshold, and the current operating tube voltage may be the second tube voltage. In some embodiments, the operations 3440 and 3450 may be performed by the adjustment module 3620.

In some embodiments, the obtaining module 3610 may obtain a second relationship between a magnitude of a tube current and a cathode emission area, and the second relationship indicates a positive correlation between the magnitude of the tube current and the cathode emission area. In the case of a high-voltage tube voltage, the smaller the tube current is, the smaller the cathode emission area corresponding to the tube current may be.

In some embodiments, the adjustment module 3620 may determine the cathode emission area corresponding to the second focal point size based on the target tube current corresponding to the second focal point size and the second relationship, and determine the potential difference corresponding to the second focal point size based on the target tube current and the cathode emission area corresponding to the second focal point size. A first area may be the cathode emission area corresponding to the target focal point size, and a second area may be the cathode emission area corresponding to the second focal point size. There may be a first relationship between the magnitude of the tube current and the potential difference. There may also be a second relationship between the magnitude of the tube current and the cathode emission area. Therefore, the potential difference corresponding to the second focal point size may be determined according to the first relationship, the second relationship, and the target tube current corresponding to the second focal point size. The manner for determining the potential difference corresponding to the second focal point size is similar to the manner for determining the second potential difference corresponding to the target focal point size, which may be seen in the relevant descriptions of the operation 2820 and will not be repeated herein.

In some embodiments, the adjustment module 3620 may adjust the potential difference between the cathode adjustment window and the cathode based on the potential difference corresponding to the second focal point size, so that the size of the electron beam spot may match the second focal point size. Since the current operating tube voltage is the second tube voltage, the adjustment module 3620 may adjust a cathode emission area of the electron beam emitted from the cathode based on the potential difference corresponding to the second focal point size, so that the size of the electron beam spot may match the second focal point size. Since the second focal point size is smaller than the target focal point size, the target tube current B corresponding to the second focal point size may be smaller than the target tube current A corresponding to the target focal point size, and the second area corresponding to the second focal point size may be smaller than the first area corresponding to the target focal point size. By adjusting the potential difference between the cathode adjustment window and the cathode, a relatively large focal point size may be adjusted to a relatively small focal point size directly by adjusting the cathode emission area.

In some embodiments, when the current operating tube voltage is the second tube voltage, a ratio of the second area to the first area may be smaller than or equal to one-fourth, so that the focal point may be adjusted within a relatively large range. For example, the first area corresponding to the relatively large target focal point size may be all of the electron emission region or most of the electron emission region of the cathode, and the second area corresponding to the relatively small second focal point size may be smaller than one-fourth of the electron emission region of the cathode.

In some embodiments, the ratio of the second area to the first area may be smaller than or equal to one-third.

In some embodiments, the ratio of the second area to the first area may be smaller than or equal to one-half.

In some embodiments, the ratio of the second area to the first area may be smaller than or equal to one-sixth.

In some embodiments, if the current operating tube voltage is the second tube voltage (i.e., the high-voltage tube voltage), a first focusing ratio of the first area to the target focal point size may be equal to a second focusing ratio of the second area to the second focal point size. The focusing ratio of the electrons refers to a result of dividing the cathode emission area by a focal area, which may reflect the ability and strength of a focusing element. In some embodiments, the first focusing ratio and the second focusing ratio may also be similar. A difference between the first focusing ratio and the second focusing ratio being smaller than a preset threshold may be considered that the first focusing ratio and the second focusing ratio are similar. The preset threshold may be set or adjusted artificially. For example, the difference between the first focusing ratio and the second focusing ratio may be smaller than 0.5. As another example, the difference between the first focusing ratio and the second focusing ratio may be smaller than 0.1. If a voltage value of the current tube voltage changes or the current tube voltage is the first tube voltage, the focusing ratios before and after the focal point size is adjusted may also be different. For example, in the case of a low-voltage tube voltage, the focusing ratio may change to obtain different focal point sizes since the cathode emission area remains constant.

In the case of the high-voltage tube voltage, in the embodiments of the present disclosure, a large cathode emission area may correspond to a large focal point size, and a small cathode emission area may correspond to a small focal point size, which is conducive to maintaining the focusing ratio of the electron beam at a balanced value, so that the focusing element may not be brought with too much burden, and it is also conducive to the stability and reliability of the overall beam. At the same time, due to the cooperation with the circular cathode and the focusing electrode, the beam spot formed by the emitted electrons may be distributed uniformly. A larger target angle can be matched at the same emission power, so that the radiation field of view may be larger. The field of view at the large focal point may cover an entire organ, and full scanning of the organ may be completed with high temporal resolution with only one-circle rotation of a gantry. Adjusting the focal point size by adjusting the cathode emission area may avoid the dispersion problem caused by focusing during the magnetic control process while realizing the adjustment of a relatively small size focal point.

In some embodiments of the present disclosure, the focal point size may be adjusted in a large range at the time of fast switching of the tube current by adjusting, based on the target focal point size or the second focal point size, the potential difference between the cathode adjustment window and the cathode. Therefore, not only microsecond tube current regulation in energy-spectrum CT may be achieved, but also the unification of high temporal resolution of a large focal point and high spatial resolution of a small focal point of energy-spectrum CT may be achieved, thereby greatly expanding the application scenarios of energy-spectrum CT.

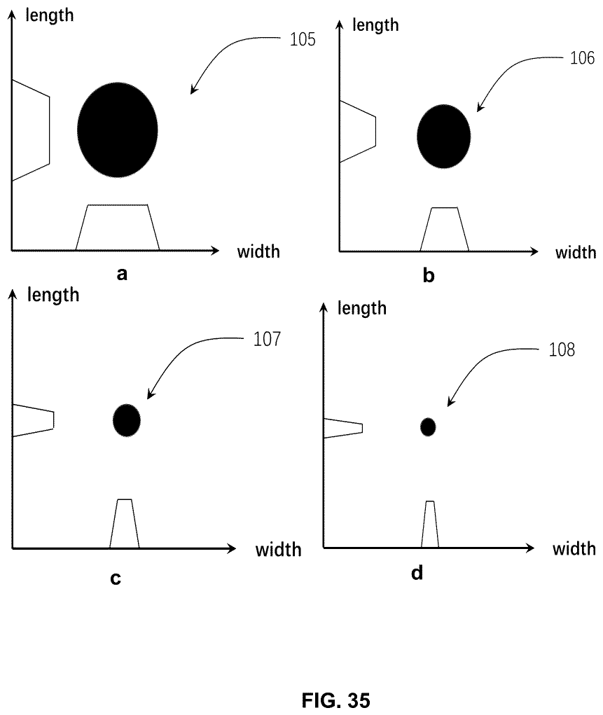

FIG. 35 is a schematic illustration of exemplary focal point sizes according to some embodiments of the present disclosure.

As shown in FIG. 35, a focal point 105 (2.5 mm) in “a” and a focal point 106 (1.5 mm) in “b” are large focal points, a focal point 107 (0.5 mm) in “c” and a focal point 108 (0.3 mm) in “d” are ultra-small focal points, and each focal point size corresponds to a current passing through the cathode. When an extra-large focus is required to accomplish a high temporal resolution scan with a high-dosage, the two large focal points of the focal point 105 and/or the focal point 106 may be obtained by adjusting a potential difference between the cathode adjustment window and the cathode. When an extra-small focus is required, the two ultra-small focal points of the focal point 107 and the focal point 108 may be obtained by adjusting a potential difference between the cathode adjustment window and the cathode. With the embodiments of the present disclosure, focal point sizes that satisfy all needs may theoretically be achieved, thereby greatly expanding the adjustment of the spatial resolution of the CT.

It should be noted that the descriptions of the process 3400 are merely provided for example and illustration, and not intended to limit the scope of application of the present disclosure. For those skilled in the art, various modifications and variations may be made to the process 3400 under the guidance of the present disclosure. However, these modifications and variations remain within the scope of the present disclosure.

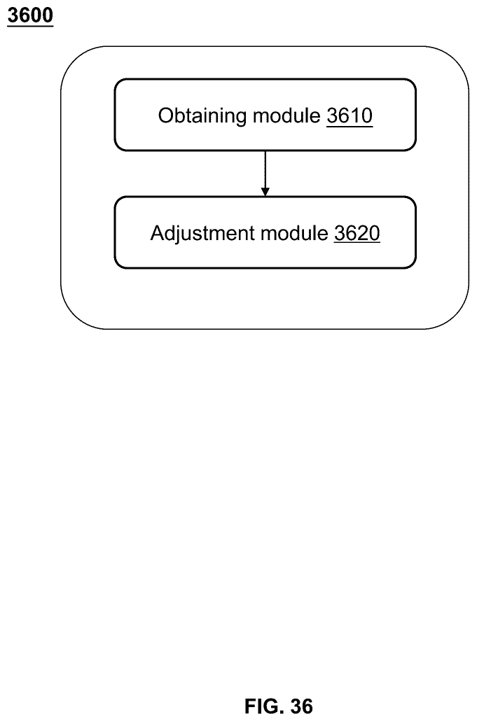

FIG. 36 is a schematic diagram of modules of a system for adjusting a focal point of an X-ray tube according to some embodiments of the present disclosure.

In some embodiments, the system 3600 for adjusting a focal point of an X-ray tube may include the obtaining module 3610 and the adjustment module 3620. The X-ray tube may include a cathode assembly. The cathode assembly may include a cathode and a cathode adjustment window. The cathode may be configured to emit an electron beam. The cathode adjustment window may be disposed at a periphery of the cathode. A potential difference may be formed between the cathode adjustment window and the cathode. A divergence angle of the emitted electron beam or a cathode emission area may be adjusted by adjusting the potential difference between the cathode adjustment window and the cathode, thereby realizing focal point adjustment. In some embodiments, the cathode adjustment window may be disposed at the periphery of the cathode. For example, the cathode adjustment window may be disposed at a partial region or an entire region of the periphery of the cathode. The X-ray tube may also include an anode assembly (e.g., a target disk). The node assembly may be configured to receive the emitted electron beam. More descriptions regarding the cathode assembly of the X-ray tube may be found in FIG. 3. More descriptions regarding the rest of the structure of the X-ray tube may be found in FIG. 3.

The obtaining module 3610 may be configured to obtain a target focal point size of the X-ray tube. In some embodiments, the obtaining module 3610 may also be configured to obtain a radiation power corresponding to the target focal point size. More descriptions regarding the obtaining the target focal point size may be found in FIG. 28.

The adjustment module 3620 may be configured to adjust emittance of the electron beams emitted from the cathode at different tube voltages by adjusting, based on the target focal point size, a potential difference between the cathode adjustment window and the cathode, so that a size of an electron beam spot may match the target focal point. In some embodiments, the adjustment module 3620 may adjust the potential difference between the cathode adjustment window and the cathode by adjusting the cathode of the adjustment window and/or a potential of the cathode.

In some embodiments, the adjustment module 3620 may be further configured to determine the target tube current at an operating tube voltage based on the target focal point size and the radiation power, and adjust a current passing through the cathode based on the target tube current, so that the cathode may emit the target tube current. In some embodiments, if a current operating tube voltage is smaller than a first tube voltage threshold, the adjustment module 3620 may be further configured to adjust a divergence angle of the electron beam emitted from the cathode based on the potential difference. In some embodiments, if the current operating tube voltage is greater than the second tube voltage threshold, the adjustment module 3620 may be further configured to adjust the cathode emission area of the electron beam emitted from the cathode based on the potential difference. More descriptions regarding the adjusting the potential difference may be found in FIG. 28.

It should be understood that the system shown in FIG. 36 and the modules thereof may be realized in various ways.

It should be noted that the descriptions of the system for adjusting a focal point of an X-ray tube and the modules thereof are merely provided for convenience of description, and not intended to limit the present disclosure to the scope of the embodiments. It is understood that for those skilled in the art, after understanding the principle of the system, it may be possible to arbitrarily combine various modules or form a sub-system to connect with other modules without departing from this principle. In some embodiments, the obtaining module 3610 and the adjustment module 3620 disclosed in FIG. 36 may be different modules in one system, or one module that implements the functions of two or more modules. For example, each module may share one storage module, or each module may have its own storage module. Such deformations are within the protection scope of the present disclosure.

Based on the same inventive concept, some embodiments of the present disclosure also provide a method for controlling a focused electron beam using the cathode assembly 210. The method may include the operations.

In S10, at least one target emission portion of a flat cathode may be determined according to a desired position and a desired size of a target focal point.

In S20, a first potential may be provided to each target emission portion.

In S30, a second potential may be provided to the focusing electrode. The second potential may be smaller than or equal to the first potential, so that the electron beam emitted from each target emission portion may be focused.

Specifically, the flat cathode in the present disclosure may include a plurality of emission portions. Each of the emission portions may be configured to independently emit an electron beam. The emission portion (i.e., the target emission portion) that emits the electron beam may be determined based on the desired position and the desired size of the target focal point. By providing the first potential to each target emission portion and providing the second potential to the focusing electrode to form an electric field in cooperation with an anode, and providing a corresponding current to each target emission portion, each target emission portion may independently emit the electron beam, so that the target focal point may be formed on a target disk.

A magnitude of the second potential of the focusing pole may be adjusted, a count of target emission portions may be adjusted, or the target emission portion may be redetermined when the size or position of the target focal point is changed.

It should be noted that a current is needed to pass through the emission portion to reach a desired cathode temperature when the emission portion emits the electron beam.

In some embodiments, the operation S30 may further include providing a corresponding second potential to a focusing pole corresponding to the target emission portion.

Specifically, the focusing electrode may include a plurality of independent focusing poles. Each focusing pole may be arranged in a one-to-one correspondence with the emission portions. By adjusting the potential of each focusing pole of the focusing electrode, the focusing of the electron beam emitted by the emission portion corresponding to the focusing pole may be controlled independently, which may be combined with adjusting the count of target emission portions or redetermining the target emission portion, thereby further enhancing the continuity and the range of the adjustment of the beam spot size and improving the adaptability of the cathode assembly.

In some embodiments, the method for controlling a focused electron beam may further include the following operation.

In S40, a third potential may be provided to the auxiliary electrode.

Specifically, by providing the third potential to the auxiliary electrode, the auxiliary electrode may cooperate with each focusing pole to control the emission portion corresponding to the focusing pole, thereby further controlling the degree of focusing of the electron beam emitted by each emission portion and improving the adaptability of the cathode assembly.

For example, as shown in FIG. 19, the flat cathode 212 may include four emission portions. The four emission portions may be the emission portion 2121, the emission portion 2122, the emission portion 2123, and the emission portion 2124, respectively. The focusing electrode 214 may include four focusing poles. The four focusing poles may be the focusing pole 2141, the focusing pole 2142, the focusing pole 2143, and the focusing pole 2144. The emission portion 2121 and the emission portion 2124 may be disposed opposite to each other in a vertical direction, and the emission portion 2122 and the emission portion 2124 may be opposite each other along a horizontal direction.

For case of description, in the present embodiment, the emission portion 2121 and the focusing pole 2141 may be taken as an example, but is not limited thereto. When the third potential of the auxiliary electrode 290 is equal to the second potential of the focusing pole 2141 and are lower than the first potential of the emission portion 2121 to a certain extent, the emission of the electron beam of the emission portion 2121 may be cut off. A range of the potential of the auxiliary electrode 290 not exceeding a potential at which the emission of the emission portion 2121 is cut off may be defined as a first preset range. When the third potential of the auxiliary electrode 290 and the second potential of the focusing pole 2141 gradually increase synchronously, the emission portion 2121 may gradually emit a current. When the third potential of the auxiliary electrode 290 and the second potential of the focusing pole 2141 increase to a certain value synchronously, the emission portion 2121 may emit a maximum emission current, i.e., the emission portion 2121 may emit electron beam 700 normally. A potential interval of the auxiliary electrode 290 corresponding to the emission portion 2121 starting to emit the current to the emission portion 2121 emitting the maximum emission current may be defined as a second preset range.

When the third potential of the auxiliary electrode 290 is not equal to the second potential of the focusing pole 2121, and when the second potential of the focusing pole 2141 is greater than the third potential of the auxiliary electrode 290, the beam spot formed by the electron beam emitted by the emission portion 2121 to the target disk may shift towards the focusing pole 2141. When the second potential of the focusing pole 2141 is smaller than the third potential of the auxiliary electrode 290, the beam spot formed by the electron beam emitted by the emission portion 2121 to the target disk may shift towards the auxiliary electrode 290.

In some embodiments, after the operation S40, the method for controlling the focused electron beam may further include the following operation.

In S50, a difference between the second potential of the focusing pole corresponding to the at least one target emission portion and the third potential of the auxiliary electrode may be adjusted.

As can be seen from the above, a difference between the second potential of the focusing pole 2142 corresponding to the target emission portion and the third potential of the auxiliary electrode 290 may be adjusted, so as to move the beam spot on the target disk. When a count of the target emission portions is one, the beam spot may move in a direction of the arrangement of the auxiliary electrode 290 and the focusing pole 2142 corresponding to the target emission portion, thereby enabling adjustment of the position of the target focal point and improving the adaptability of the cathode assembly.

Taking FIG. 19 as an example, when the count of the target emission portions is one and is the emission portion 2121, and the difference between the second potential of the focusing pole 2141 and the third potential of the auxiliary electrode 290 is adjusted, the position of the beam spot emitted by the first emission portion 2121 may be adjusted in a vertical direction. When there are a plurality of target emission portions, magnitudes of the second potentials of a plurality of corresponding focusing poles 2142 in the plurality of target emission portions may be adjusted according to the position of the target focal point to realize the adjustment of the position of the target beam spot. The specific adjustment realization manner is the same as that when the count of the target emission portions is one, and the difference is only in the count of the target emission portions, so the manner will not be repeated herein.

In some embodiments, in S50, the method for controlling the focused electron beam may further include:

periodically changing a difference between the second potential of the focusing pole 2142 corresponding to the at least one target emission portion and the third potential of the auxiliary electrode 290.

Specifically, when the count of the target emission portions is one and the target emission portion is the emission portion 2121, and the difference between the second potential of the focusing pole 2141 and the third potential of the auxiliary electrode 290 is periodically changed, the position of the beam spot emitted by the emission portion 2121 may be periodically adjusted in the vertical direction to realize a small-distance focus shift in the vertical direction, i.e., realize a small-distance focus shift in a direction of the arrangement of the focusing pole 2142 and the auxiliary electrode 290, thereby realizing dynamic adjustment of the position of the beam spot and improving the adaptability of the cathode assembly.

It should be noted that when there are a plurality of target emission portions, the magnitudes of the second potentials of a plurality of focusing poles in the plurality of target emission portions may be periodically changed to realize the adjustment of small-distance focus shift of the position of the target beam spot.

In some embodiments, the operation S40 may further include the following operations.

In S41, the third potential may be adjusted to the first preset range.

In S42, the second potential of the focusing pole corresponding to the target emission portion in an emission state may be adjusted to be equal to the third potential, so as to change the target emission portion from the emission state to an emission suppression state; the second potential of the focusing pole corresponding to the target emission portion in the emission suppression state may be adjusted to be greater than the third potential of the auxiliary electrode 290, so as to change the target emission portion from the emission suppression state to the emission state, thereby realizing the switching of the emission of electron sources.

Specifically, taking FIG. 19 as an example, when there are two target emission portions (i.e., the emission portion 2121 and the emission portion 2123), the third potential of the auxiliary electrode 290 is in the first preset range, the second potential of the focusing pole 2141 is equal to the third potential, and the second potential of the focusing pole 2143 is greater than the third potential, at this time, the electron beam emission of the emission portion 2121 may be cut off, that is, the emission portion 211 may be in the emission suppression state, or the emission portion 2123 may emit the electron beam, that is, the emission portion 211 may be in the emission state. When the second potential of the focusing pole 2143 is adjusted to be equal to the third potential, and the second potential of the focusing pole 2141 is adjusted to be greater than the third potential, and at this time, the beam emission of the emission portion 2123 may be cut off, that is, the emission portion 2123 may be in the emission suppression state, and the emission portion 2121 may emit the electron beam, that is, the emission portion 2121 may be in the emission state. In this way, switching of electron sources between the emission portion 2121 and the emission portion 2123 may be realized, and a great-distance focus shift of the beam spot in the vertical direction may be realized, thereby realizing the great-distance focus shift on the basis of a relatively small change in the beam trajectory, and guaranteeing the safety, stability, reliability of the beam.

The two target emission portions may also be other combination. The switching of the electron sources between the emission portion 2122 and emission portion 2124 may also be achieved by controlling the emission current of the emission portion 2122 using the auxiliary electrode 290 and focusing pole 2142, and controlling the emission current of the emission portion 2124 using the auxiliary electrode 290 and the focusing pole 2144. That is, the target emission portion can be any two emission portions. In the present disclosure, focus shift between any two combined emission portions may be realized, thereby realizing the dynamic adjustment of the beam spot at any position on the target disk and further improving the adaptability of the cathode assembly.

It should be noted that the above embodiments are merely provided for the sake of description, and there may be a plurality of target emission portions. When there are the plurality of target emission portions, the third potential of the auxiliary electrode 290 may be adjusted to be in the first preset range, the second potential of the focusing pole 2142 corresponding to one or more target emission portions may be adjusted to be equal to the third potential of the auxiliary electrode 290, and the second potential of the focusing pole 2142 corresponding to one or more target emission portions may be adjusted to be greater than the third potential of the auxiliary electrode 290. The second potential of the focusing pole 2142 corresponding to at least one target emission portion in the emission state may be adjusted to be equal to the third potential of the auxiliary electrode 290, and the second potential of the focusing pole 2142 corresponding to at least one target emission portion in the emission suppression state may be adjusted to be greater than the third potential of the auxiliary electrode 290, thereby achieving the switching of multiple electron sources, enhancing the dynamic adjustment range of the beam spot at any position on the target disk, and further improving the adaptability of the cathode assembly.

In some embodiments, the switching of electron source emission may be achieved. Compared to the prior art where the switching of the electronic source emission is realized by cooling, by stopping the power supply, the emission portion, the switching of the microsecond-level current switching may be achieved in the embodiments of the present disclosure, which is of great significance for reducing the patient dose and balancing the dose in multi-energy radiotherapy.

It should be noted that in some embodiments, a general electronic focus shift function may be realized by a periodic change in the potential difference between the focusing electrode 214 and the auxiliary electrode 290, and a third type of focus shift other than electronic focus shift and magnetic focus shift may be realized by controlling the switching of emission and suppression of the electron beam in the two emission portions. Combining the periodic change in the potential difference between the focusing pole and the auxiliary electrode with electron source emission switching enables great-distance focus shift while ensuring a very small change in the electron trajectory of each emission portion, thereby better ensuring the safety, stability, and reliability of the beam.

In some embodiments, the following operation may be further included between the operations S41 and S42.

The second potential of the focusing pole corresponding to one target emission portion may be adjusted to be equal to the third potential of the auxiliary electrode 290, so as to cause the target emission portion to be in the emission suppression state. The second potential of the focusing pole corresponding to another target emission portion may be adjusted to be greater than the third potential, so as to cause the target emission portion to be in the emission state. That is, it is ensured that at least one emission portion of the target emission portions is in the emission suppression state and at least one emission portion of the target emission portions is in the emission state.

In some embodiments, after the operation S40, the following operation may be further included.

The third potential may be adjusted to be within the second preset range.

The second potential of the focusing pole corresponding to the target emission portion may be adjusted to be equal to the third potential of the auxiliary electrode 290.

The second potential of the focusing pole corresponding to the target emission portion and the third potential of the auxiliary electrode 290 may be synchronously adjusted to be within the second preset range, so that the second potential and the third potential remain equal to adjust an intensity of the electron beam emitted from the target emission portion.

Specifically, the third potential may be within the second preset range. When the second potential of the focusing pole corresponding to the target emission portion is equal to the third potential of the auxiliary electrode 290, the target emission portion may emit a portion of the electron beams. As the second potential and the third potential increase synchronously, the tube current may increase. As the second potential and the third potential decrease synchronously, the tube current may decrease. It should be noted that the second potential and the third potential of the auxiliary electrode 290 always remain equal.

In some embodiments, the target emission portion being the emission portion 2121 may be taken as an example. When the second potential of the focusing pole 2141 is adjusted to be equal to the third potential of the auxiliary electrode 290 and to be within the second preset range, the emission portion 2121 may emit a portion of the electron beams. When the second potential of the focusing pole 2141 and the third potential of the auxiliary electrode 290 are synchronously adjusted, a count of electron beams emitted by the emission portion may be adjusted, thereby adjusting the intensity of the tube current from the emission portion. That is, in the present disclosure, the tube current may be accurately controlled in real time by the focusing electrode and the auxiliary electrode, thereby realizing real-time and accurate dose adjustment. This approach plays a huge role in the reduction of ineffective dose, dose balance of dual-energy scanning, and faster rate of change of dose.

It should be noted that although the emission portion 2121 is illustrated as an example, in other embodiments, the target emission portion may be changed, and a count of target emission portions may be two, or more, thereby further expanding the range of the adjustment of the intensity of the tube current from the flat cathode.

It should be noted that since the auxiliary electrode and the focusing pole usually operate in the order of kilovolts during normal operation, it is understood that the potential of the auxiliary electrode and the potential of the focusing pole may be allowed to be different within a few volts or even tens of volts, and the potential of the auxiliary electrode and the potential of the focusing pole are considered to be equal in this case.

In some embodiments, the method for controlling the focused electron beam may further include:
obtaining current information of the electron beam emitted by each target emission portion;
determining a failed target emission portion based on the current information of the electron beam emitted by each target emission portion; and
performing at least one of: adjusting the second potentials of the focusing poles, adjusting the current of the target emission portions, and redetermining a new target emission portion to replace the failed target emission portion.

Specifically, when the target emission portion fails, the size or current of the target focal point may change. When the tube current changes, the current of the target emission portion may be adjusted. When the size of the beam spot changes, the target emission portion may be re-determined, or the second potentials of the focusing poles may be adjusted to achieve the same function and guarantee performance continuity.

For example, taking FIG. 19 as an example, when the target emission portion is the emission portion 2121, and the obtained current of the emission portion 2121 is 0, the emission portion 2121 may not emit the electron beam, so that the emission portion 2121 may fails, and the size of the spot on the target disk may differ from the target focal point. At this time, the current may be provided for the emission portion 2122 and the emission portion 2124, so that the emission portion 2124 and the emission portion 2122 may emit the electron beams to adjust the size of the beam spot, thereby achieving the same function and guaranteeing the performance continuity.

In the embodiment, only the emission portion 2121, the emission portion 2122, and the emission portion 2124 are taken as an example, which is not limited thereto. That is, in some embodiments, through the independent control of a plurality of emission portions, it can be ensured that even if a certain emission portion fails, the same function can be achieved by combining other emission portions, thereby improving adaptability and reliability.

The following beneficial effects achieved by the cathode assembly, the method for adjusting a focal point of an X-ray, and the method for controlling a focused electron beam described in some embodiments of the present disclosure may at least include the followings. 1) Each cathode sheet can independently emit an electron beam, which facilitates the adjustment of the size of the beam spot and the size of the focal point, enhances the adaptability of the cathode assembly under different focal point size requirements, and enables continuous adjustment from an ultra-small focal point to an ultra-large focal point, thereby providing more focal point choices for clinical applications and utilizing each region of the target material more efficiently. 2) Under different focal point size requirements, the difference in the current passing through each emission portion is relatively small, which is conducive to beam current stability and functional continuity of the cathode sheets, and extends the service life of the cathode sheets. 3) By changing the count of the cathode sheets, the shape of the cathode sheets, and the shapes of the focusing poles and the cathode sheets, diversified demands of a user can be satisfied. 4) By adjusting the potential difference between the emission portion of the flat cathode, the focusing electrode, and the auxiliary electrode, the emission and focusing of the electron beams can be realized, and the position of the focal point can be changed by adjusting the potential difference, thereby improving the adaptability of the cathode assembly and satisfying the needs of the user for different spot positions. 5) The great-distance focus shift can be achieved with the relatively small change in the beam trajectory, thereby ensuring the safety and stability of the beam and reducing patient radiation dose. and 6) The compact arrangement of the emission portions can reduce the volume of cathode assembly.

The cathode assembly and the method for adjusting a focal point corresponding the cathode assembly disclosed in some embodiments of the present disclosure can improve the safety and accuracy of X-ray diagnosis, and the reliability and stability of the X-ray device. For example, special advantages in various applications may include, but not limited to the followings. 1) In scenarios where focal point size adjustment and focal point position adjustment are required, including but not limit to adjusting resolution using the focal point, adjusting resolution by changing the focal point position, etc. in CT or interventional scenarios, more diverse focal point sizes and positions can be achieved, faster and more precise adjustments can be performed, and better integration with other components (e.g., electric field components, magnetic field components) can be achieved. 2) In scenarios where rapid adjustment of X-ray dose or electron current is required, including but not limit to dose reduction and dose balancing in CT or interventional scenarios, the beam brightness may be adjusted faster and more accurately, which is conducive to imaging and the dose safety of the patient. 3) In scenarios where better electron beam distribution is required, including but not limit to adjusting the electron beam distribution to increase the power and improve the image quality, etc. in CT or interventional scenarios, a more uniform focal point can be obtained. and 4) In scenarios where the reliability and service life of the cathode assembly need to be improved, including but not limit to compensating for individual failed filament in CT or interventional scenarios, the reliability and service life of the cathode assembly can be significantly improved to ensure the normal operation of the bulb tube and the entire the X-ray device.

Having thus described the basic concepts, it may be rather apparent to those skilled in the art after reading this detailed disclosure that the foregoing detailed disclosure is intended to be presented by way of example only and is not limiting. Although not explicitly stated here, those skilled in the art may make various modifications, improvements and amendments to the present disclosure. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various parts of this specification are not necessarily all referring to the same embodiment. In addition, some features, structures, or features in the present disclosure of one or more embodiments may be appropriately combined.

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. However, this disclosure does not mean that the present disclosure object requires more features than the features mentioned in the claims. Rather, claimed subject matter may lie in less than all features of a single foregoing disclosed embodiment.

In some embodiments, the numbers expressing quantities or properties used to describe and claim certain embodiments of the present disclosure are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the present disclosure are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the present disclosure disclosed herein are illustrative of the principles of the embodiments of the present disclosure. Other modifications that may be employed may be within the scope of the present disclosure. Thus, by way of example, but not of limitation, alternative configurations of the embodiments of the present disclosure may be utilized in accordance with the teachings herein. Accordingly, embodiments of the present disclosure are not limited to that precisely as shown and described.

What is claimed is:

1. An X-ray tube, comprising a cathode structure, wherein the cathode structure includes:
a cathode configured to emit an electron beam;
a cathode adjustment window disposed at a periphery of the cathode; and
a controller configured to adjust emittance of the electron beams emitted from the cathode at different tube voltages by adjusting, a potential difference between the cathode adjustment window and the cathode, so that a size of an electron beam spot formed by the electron beam matches a target focal point size.

2. The X-ray tube of claim 1, wherein
the potential difference between the cathode adjustment window and the cathode is adjusted one or more times to make the size of the electron beam spot of the electron beam emitted by the cathode be the target focal point size.

3. The X-ray tube of claim 1, wherein
a first potential difference corresponding to the target focal point size at a current tube voltage is determined based on the target focal point size; and
the potential difference between the cathode adjustment window and the cathode is adjusted based on the first potential difference.

4. The X-ray tube of claim 1, wherein
the cathode includes at least two emission portions, each of the at least two emission portions being configured to independently emit an electron beam; and
the at least two emission portions are circumferentially arranged around a center of the cathode.

5. The X-ray tube of claim 4, wherein
the cathode structure further includes a focusing electrode, the focusing electrode being configured to focus the electron beam;
an emission surface of the cathode forms a first acute angle with a central axis of the X-ray tube; and
a focusing surface of the focusing electrode forms a second acute angle with the central axis of the X-ray tube.

6. The X-ray tube of claim 5, wherein the focusing electrode includes at least two focusing poles, the at least two focusing poles being arranged in a one-to-one correspondence with the at least two emission portions.

7. The X-ray tube of claim 6, wherein the cathode structure further includes an auxiliary electrode, the auxiliary electrode is arranged within a fitting hole surrounded by the at least two emission portions, and the auxiliary electrode is configured to cooperate with the focusing electrode to control the electron beams emitted by the at least two emission portions.

8. The X-ray tube of claim 7, wherein an insulating layer is provided between the auxiliary electrode and the at least two emission portions.

9. The X-ray tube of claim 4, wherein adjacent edges of any two adjacent emission portions of the at least two emission portions are parallel.

10. The X-ray tube of claim 1, further comprising a magnetron unit, wherein the magnetron unit is configured to focus the electron beam emitted by controlling at least one emission portion through the cathode adjustment window.

11. The X-ray tube of claim 1, wherein the cathode is circular or elliptical.

12. A method for adjusting a focal point of an X-ray tube, wherein the X-ray tube includes a cathode and a cathode adjustment window, and the cathode is configured to emit an electron beam, the method comprising:
obtaining a target focal point size of the X-ray tube; and
adjusting emittance of the electron beams emitted from the cathode at different tube voltages by adjusting, a potential difference between the cathode adjustment window and the cathode, so that a size of an electron beam spot matches the target focal point size;
wherein the cathode adjustment window is disposed at a periphery of the cathode.

13. The method of claim 12, further comprising:
obtaining a radiation power corresponding to the target focal point size;
determining a target tube current at an operating tube voltage based on the target focal point size and the radiation power; and
adjusting a current passing through the cathode based on the target tube current, so that the cathode emits the target tube current.

14. The method of claim 13, wherein the adjusting emittance of the electron beams emitted from the cathode at different tube voltages by adjusting, based on the target focal point size, a potential difference between the cathode adjustment window and the cathode, so that a size of the electron beam spot matches the target focal point size includes:
in response to determining that a current operating tube voltage is less than a first tube voltage threshold, adjusting, based on the potential difference, a divergence angle of the electron beam emitted from the cathode; or
in response to determining that the current operating tube voltage is greater than a second tube voltage threshold, adjusting, based on the potential difference, a cathode emission area of the electron beam emitted from the cathode, wherein the first tube voltage threshold is less than or equal to the second tube voltage threshold.

15. The method of claim 14, wherein the adjusting, based on the potential difference, a divergence angle of the electron beam emitted from the cathode includes:
determining a first potential difference based on the target tube current and the divergence angle; and
adjusting the cathode adjustment window based on the first potential difference.

16. The method of claim 14, wherein the adjusting, based on the potential difference, a cathode emission area of the electron beam emitted from the cathode includes:
obtaining a first relationship between a magnitude of a tube current and the potential difference;
determining a second potential difference based on the target tube current and the first relationship; and
adjusting the cathode adjustment window based on the second potential difference.

17. The method of claim 13, wherein the operating tube voltage includes a first tube voltage and a second tube voltage, and the adjusting emittance of the electron beams emitted from the cathode at different tube voltages by adjusting, based on the target focal point size, a potential difference between the cathode adjustment window and the cathode, so that a size of the electron beam spot matches the target focal point size includes:
determining a first potential difference between the cathode adjustment window and the cathode at the first tube voltage based on the target focal point size, the radiation power, and the first tube voltage;
determining a second potential difference between the cathode adjustment window and the cathode at the second tube voltage based on the target focal point size, the radiation power, and the second tube voltage; and
adjusting the cathode adjustment window based on the first potential difference and the second potential difference.

18. The method of claim 17, wherein the first tube voltage is less than a first tube voltage threshold, the second tube voltage is greater than a second tube voltage threshold, the first tube voltage threshold is less than or equal to the second tube voltage threshold, the first potential difference is used to adjust a divergence angle of the electron beam emitted from the cathode, and the second potential difference is used to adjust a cathode emission area of the electron beam emitted from the cathode.

19. The method of claim 13, further comprising:
obtaining a second focal point size of the X-ray tube and a target tube current corresponding to the second focal point size, wherein the second focal point size is smaller than the target focal point size;
obtaining a second relationship between a magnitude of a tube current and a cathode emission area, the second relationship indicating a positive correlation between the magnitude of the tube current and the cathode emission area;
determining the cathode emission area corresponding to the second focal point size based on the second relationship and the target tube current corresponding to the second focal point size;
determining a potential difference corresponding to the second focal point size based on the target tube current and the cathode emission area corresponding to the second focal point size; and
adjusting the cathode adjustment window based on the potential difference corresponding to the second focal point size, wherein a current operating tube voltage is greater than the second tube voltage threshold.

20. An X-ray device, comprising an X-ray tube, the X-ray tube including a cathode structure, wherein the cathode structure includes:
a cathode configured to emit an electron beam;
a cathode adjustment window disposed at a periphery of the cathode; and
a controller configured to adjust emittance of the electron beams emitted from the cathode at different tube voltages by adjusting a voltage of at least one of the cathode adjustment window and the cathode, so that a size of an electron beam spot formed by the electron beam matches a target focal point size.
